(19) United States
(12) Patent Application Publication
(10) Pub. No.: US 2015/0199529 A1
(43) Pub. Date: Jul. 16, 2015

(54) SYSTEM, METHOD, AND APPARATUS FOR USING A VIRTUAL BUCKET TO TRANSFER ELECTRONIC DATA

(71) Applicant: Einar ROSENBERG, Miami, FL (US)

(72) Inventor: Einar ROSENBERG, Miami, FL (US)

(21) Appl. No.: 14/524,657

(22) Filed: Oct. 27, 2014

Related U.S. Application Data
(63) Continuation-in-part of application No. 14/466,837, filed on Aug. 22, 2014.
Application No. 14/466,837 is a continuation-in-part of application No. 14/455,553, filed on Aug. 8, 2014.
Application No. 14/455,553 is a continuation-in-part of application No. 14/191,338, filed on Feb. 26, 2014.
Application No. 14/191,338 is a continuation-in-part of application No. 14/177,104, filed on Feb. 10, 2014.
(60) Provisional application No. 61/895,524, filed on Oct. 25, 2013.
(60) Provisional application No. 61/913,298, filed on Dec. 8, 2013.
(60) Provisional application No. 61/868,681, filed on Aug. 22, 2013.
(60) Provisional application No. 61/863,529, filed on Aug. 8, 2013.
(60) Provisional application No. 61/769,680, filed on Feb. 26, 2013.
(60) Provisional application No. 61/762,952, filed on Feb. 10, 2013.

(51) Int. Cl. G06F 21/60; G06F 21/64; H04W 12/02

(52) U.S. Cl. CPC G06F 21/606; H04W 12/02; G06F 21/645

(57) ABSTRACT

A system that enables a first computing system to transfer data to a second computer system using communication data read from the second computing system. The first system transfers the data which is temporarily held in a location of a third computing system associated with the communication data until the second device removes or is provided the data. Once the data is removed, the location in the third computing system where the data was temporarily held is emptied.

### CROSS REFERENCE TO RELATED APPLICATIONS

This application claims the benefit of U.S. provisional patent application No. 61/895,524, filed Oct. 25, 2013, the disclosure of which is incorporated herein by reference in its entirety.

This application claims the benefit of U.S. provisional patent application No. 61/913,298, filed Dec. 8, 2013, the disclosure of which is incorporated herein by reference in its entirety.

This application is a continuation-in part of U.S. patent application Ser. No. 14/466,837, filed Aug. 22, 2014, which claims the benefit of U.S. provisional patent application No. 61/868,681, filed Aug. 22, 2013, the disclosures of which are incorporated herein by reference in their entirety.

This application is a continuation-in part of U.S. patent application Ser. No. 14/455,553, filed Aug. 8, 2014, which claims the benefit of U.S. provisional patent application No. 61/863,529, filed Aug. 8, 2013, the disclosures of which are incorporated herein by reference in their entirety.

This application is a continuation-in part of U.S. patent application Ser. No. 14/191,338, filed Feb. 26, 2014, which claims the benefit of U.S. provisional patent application No. 61/769,680, filed Feb. 26, 2013, the disclosures of which are incorporated herein by reference in their entirety.

This application is a continuation-in part of U.S. patent application Ser. No. 14/177,104, filed Feb. 10, 2014, which claims the benefit of U.S. provisional patent application No. 61/762,952, filed Feb. 10, 2013, the disclosures of which are incorporated herein by reference in their entirety.

### BACKGROUND OF THE INVENTION

More and more mobile communication devices, e.g., SmartPhones, incorporate programs and apps that allow the devices to exchange—provide, share, and/or receive information—in various ways and using various methods. SmartPhones can directly exchange information using communication directly between two SmartPhones, e.g., using NFC or Bluetooth communication methods to establish a communications link between the two devices. SmartPhones can exchange information using indirect communication between two SmartPhones, e.g., using Wi-Fi or cellular communication methods to establish a communication link between the two devices. SmartPhones can exchange information using a third party to establish indirect communication between two SmartPhones, e.g., using a third party server to establish a communication link between the two devices.

Regardless of how the information is exchanged between the two SmartPhones, it is desirable to have reasonable assurance that the communication of information between the SmartPhones is secure and reliable. Furthermore, it is desirable that at least one party be made aware of the information being compromised.

### BRIEF DESCRIPTION OF THE DRAWINGS

FIGS. 1A-C depicts a basic overview of the invention;

FIG. 2 depicts an exemplary data transfer system;

FIG. 3 depicts a process flow for the data transfer system of FIG. 2;

FIG. 4 depicts another aspect of a data transfer system;

FIG. 5 depicts a process flow for the data transfer system of FIG. 4;

FIG. 6 depicts yet another aspect of a data transfer system;

FIG. 7 depicts a process flow for the data transfer system of FIG. 6;

FIG. 8 depicts a process flow for yet another data transfer system;

FIGS. 9A-F depict an additional data transfer system;

FIGS. 10A-B depict another data transfer system;

FIG. 11 depicts another exemplary data transfer system;

FIGS. 12A-B depict screen images that may occur during an aspect of the another exemplary data transfer system;

FIG. 13 depicts another screen image that may occur during an aspect of the another exemplary data transfer system;

FIG. 14 depicts yet another screen image that may occur during an aspect of the another exemplary data transfer system; and

FIGS. 15A and 15B depict exemplary process flows for the data transfer system of FIGS. 11-14.

### DETAILED DESCRIPTION OF THE INVENTION

In the following detailed description, reference is made to the accompanying drawings, which form a part hereof, and in which is shown by way of illustration specific exemplary embodiments of the invention. These embodiments are described in sufficient detail to enable those of ordinary skill in the art to make and use the invention, and it is to be understood that structural, logical, or other changes may be made to the specific embodiments disclosed without departing from the spirit and scope of the present invention.

The invention discloses a method for increasing security of transferring information between a first computing system, e.g., a desktop/server/institutional computer system or a first mobile communication device, to a second computing system, e.g., a second mobile communication device. In an aspect, a user uses his mobile communication device to indirectly establish communications with a second user's mobile communication device using a third party's computing system. The third party computing system creates a ‘virtual bucket’ for temporarily storing and transferring data. An example of third party temporary storage systems includes Creating Revolutions' Virtual Bucket—vBukit—system. See, for example, www.CreatingRevolutions.com and U.S. patent application Ser. No. ______ and related patent applications.

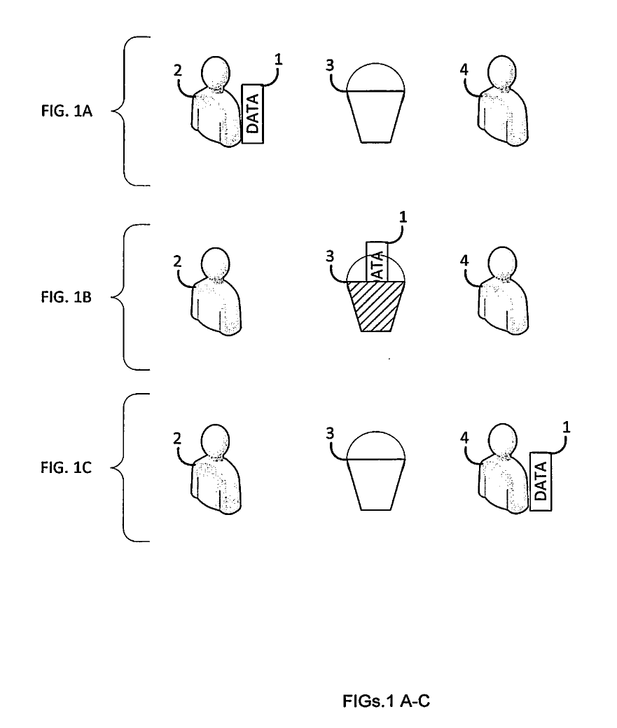

In a basic overview of the invention, as depicted in FIG. 1A, a first party 2, a providing party, has some data 1 that the first party wants to transfer to/share with a second party 4, a receiving party. First party 2 uses an intermediary, a bucket 3, to provide the data 1 to the second party 4. Preferably, the bucket 3 is empty, as depicted by the un-shaded bucket, prior to data 1 being placed into the bucket 3. As depicted in FIG. 1B, the first party 2 places the data 1 into the bucket 3, as indicated by the data 1 being in the bucket 3, and as depicted by the bucket now being shaded. Subsequently, as depicted in FIG. 1C, the second party 4 receives the data 1 from the bucket 3. The bucket 3 has been emptied as depicted by the bucket being un-shaded. Thus, the data 1 has been transferred or shared from the first party 2 to the second party 4. Although the invention may be disclosed with respect to the use of certain terminology which suggests which device or system creates actions, the invention is not so limited. For example, the invention may describe a device A providing data to a device B, which suggests that device A is substantially performing the actions. In many instances, the action can also be described as device B receiving and/or retrieving data from doing

[symbol]

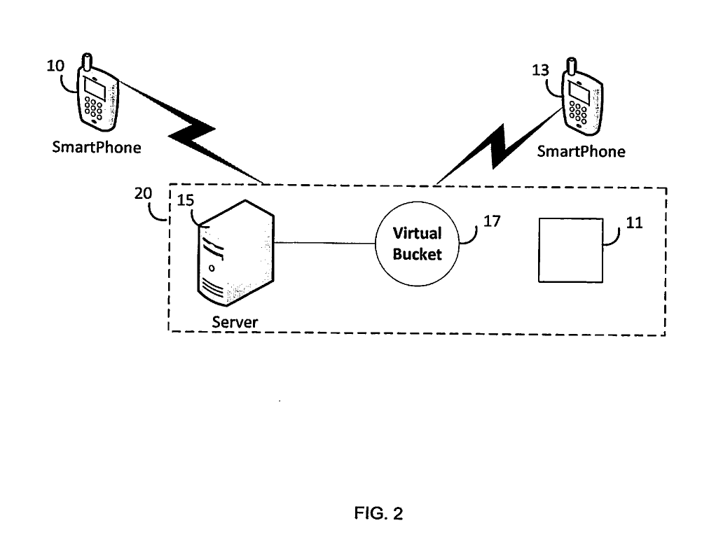

In a more detailed approach, a FIG. 2 depicts data transfer system 5 and method in accordance with an exemplary embodiment of the invention using a virtual bucket system. The system 5 includes a first computer system 10, a second computer system 13 and a third computer system 20. Depending on the implementation, the first, second and third computing systems can be any appropriate computing system, where a computing system is, for example, a computer server, a desktop computer, Tablet, Laptop computer, a mobile communication device, or an intelligent device. A mobile communication device is, for example, a Smartphone, like an Apple iPhone® or a Samsung S5®. An intelligent device is, for example, a device or appliance that includes computing features, like a Smart TV, Smart thermostat, and a Smart toilet.

In a first aspect, the computer system 10 is the receiver of information and the computer 13 is the provider of the information. In a second aspect, the computer system 10 is the provider of information and the computer 13 is the receiver of the information. Features described with respect to computer system 10 can also be applicable to computer system 13.

In certain applications, the third computer system 20 includes a computer system 15 which includes a storage area 17, e.g., a virtual bucket, and, in an aspect, an informational tag 11.

In an aspect, server 15 including the virtual bucket 17 is a general public service such as Gmail or Facebook or Amazon server, which permits a person to sign up and to setup an account. That will then allow them to either download an app to their computer or they can run it via a web portal. They will be issued an informational tag 11 corresponding to that account.

In another aspect, the server 15 including the virtual bucket 17 is a non-public, higher security, dedicated, partially or totally, server In an exemplary approach, the virtual bucket deletes the data being held upon a command. In another approach, the virtual bucket is designed to securely hold the information till the next person that securely communicates to the server and new data is transferred to the virtual bucket for downloading.

Server 15 manages the bucket 17. Consequently the server 15 has and/or provides rules on how to manage the bucket 17. Server 15 may be associated with the user of computer system 10 or may be associated with computer system 13 or not associated with either computer system and may be an independent system. Depending on the association determines who ultimately is the manager of the virtual bucket. For example, in a retail environment, e.g., the dentist office scenario discussed below, the virtual bucket is likely associated with the retail business, e.g., the dentist's office. The manager can provide rules for managing the virtual bucket. The server 15 executes a virtual bucket program on the server 15 that when executing manages at least one virtual bucket in its memory. The management includes enabling a first device to access and upload data to be stored in a memory location (e.g., identified by the communication data), storing the data, and enabling a second device to access and download data stored in the memory location (e.g., identified by the communication data). In an aspect, instructions of the virtual bucket program of the server 15 includes a method for determining what server, location of server, instructing a method of communication such as using Bluetooth or Wi-Fi to communicate with a localized device such as the computer system being nearby, or on the same network as the mobile device will communicate by. The instructions of the virtual bucket program of the computer 15 can also have instructions to how communicate; for example, app to app, where the app on the phone is instructed on how to communicate with the app on the computer system. This is akin to setting up a virtual private network. The instructions can also include additional security aspects such as an RSA key, a public/private key encryption, etc. The instructions are instructions, and can vary, but at the end, are designed to tell the phone where and how to communicate to the computer system holding the virtual bucket.

The server 15 maintains a linking database, which maintains the relationship information between an associated computer system, e.g., computer system 13, and a particular virtual buckets, e.g., virtual bucket 17. The linking database also maintains the relationship information between tags, e.g., identification information of a tag 11, and virtual buckets, e.g., virtual bucket 17. In an aspect, the later database is based on USI. The server 15 uses these databases to determine the appropriate memory location for the computer system 13 and the appropriate memory location corresponding to identification information of a tag 11.

In an exemplary approach, the virtual bucket 17 deletes the data being held in the virtual bucked after the data has been requested and provided to the computer system 10 so that no copy of the data remains on the server 15, e.g., the server deletes the virtual bucket 17 and any data contained therein. When requested, the server 15 then creates a new virtual bucket 17 having a new USI associated with it and updates its internal linking databases and in certain aspects conveys, directly or indirectly the USI for the new virtual bucket preferably to computer system 13 and tag 11, respectively. In another approach the virtual bucket 17 deletes the data being held in the virtual bucked upon receiving a command so that no copy of the data remains on the server 15. In another approach, the virtual bucket 17 securely holds the data in the virtual bucket 17 until new data is transferred to the virtual bucket for downloading. In a preferred approach, the actual location of the virtual bucket in the storage area of computer system 15 changes from one storage of information to the next storage of information, the computer system 15 determines the current location of the virtual bucket in the storage area of computer 15. After information has been provided from the virtual bucket to a receiving computer system, the storage area corresponding to the virtual bucket is overwritten with non-significant data. When another request for storing data is received, preferably a new location in its memory is used to store the new data and the computer system 15 tracks the new memory location so that it locate it when needed. In an aspect, after the file has been requested and transferred out of the virtual bucket and the virtual bucket and the information it contained has been deleted by the computer server, if a party subsequently requests a file from the deleted virtual bucket, then the subsequent requesting is notified by the server, in some form or fashion, that the file is no longer available.

Although depicted as a single virtual bucket 17, the invention is not so limited, and the server 15 can have a plurality of virtual buckets 17. Further the system 5 only depicts one server 15, the invention is not so limited and the system 5 can have a plurality of servers 15.

Preferably, the server 15 is a separate computer system from computer system 13. In other aspects, the server 15 is the same as or an associated computer system with computer system 13.

In an aspect the informational tag 11 is an NFC tag and using the information from that NFC tag, will link it to an existing account or create an account based on that pre-encoded tag. In an aspect, the identifying information of the tag 11 received from the computer system 10 is used by the computer server 15 to determine the account. In an aspect, this account is literally the virtual bucket and the corresponding dynamic id that is created, e.g., the id is address information for part, e.g., folder, of the account that will hold information, e.g., the bucket. Once they have the account on the server, and the NFC tag encoded to link to that account, the NFC mobile communication device simply uses the app installed on the phone, which they registered their own account, and processes the methods as described in the flow charts below.

In another aspect, the informational tag 11 is an information descriptor symbol, e.g., like a barcode, 3D barcode, etc., that is generated by the computers system 20 to correspond to a virtual bucket 17 and have an associated manager. In an aspect, the code is displayed or caused to be displayed by the computer system 20 and/or provided to another computer system, e.g., computer system 13, which then can be displayed or provided by computer system 13. For example, computer system 13 requests a virtual bucket from computer system 20, the computer system 20 creates a virtual bucket 17 for the computer system 13, creates the appropriate entry in a virtual bucket database to correlate computer system 13 to this virtual bucket 17. As such, computer system 13 is generally the manager or managing device of the virtual bucket 17. Computer system 20 creates, e.g., dynamically, an information tag 11 that contains information that identifies the virtual bucket 17. In a preferred approach, the informational tag 11 is dynamically created at time of need or shortly beforehand.

In some applications, computer system 10 is enabled with several methods of communicating: close proximity communications, local communications, distant communications. Communication methods include, but are not limited to, near field communications (NFC), Wi-Fi, Bluetooth communications, Cellular voice and data communications, Wireless USB, Ethernet, infrared (and other photon based communication systems), visual communications (including various bar code and other image based communications), and any other wireless or wired communication method which enables the computer system 10 and/or computer system 13 to communicate with another computing system.

In an aspect, the computer system 10 is running an appropriate program, e.g., a Virtual Bucket app for a mobile communication device, for the context of the device and the context of use, e.g., electronic data exchange with another computing system using a virtual bucket. Although generally referred to as an app, this is a general reference to a software program and can be and generally is referred to by several different names, e.g., an app, program, application, plug-in, etc., that, for all intents and purposes, achieves the same desired goal. The virtual bucket app on the computer system 10 performs and/or causes the computer system 10 and/or computer system 13 to perform the actions necessary to transfer electronic data to a virtual bucket or from a virtual bucket. The Virtual Bucket app effectuates transferring electronic data from the computer system 10 and/or computer system 13 to an identified virtual bucket 17 for transfer to another computing system 15. In another aspect, the Virtual Bucket app effectuates transferring electronic data to the computer system 10 and/or computer system 13 from an identified virtual bucket 17 which received the data from to another computing system 13 and/or computer system 10.

In an approach, a user on the receiving device 10 navigates using the Internet the device 10 to the URL for a virtual bucket provider, e.g., Vbukit.com, which corresponds to the system 20. The user does the appropriate steps to request a Virtual Bucket, e.g., the user creates an account or logs into a previously existing account, or on virtual bucket provider's website takes the appropriate steps to create a virtual bucket on that website and the server corresponding to the website. The system 20 creates a virtual bucket 17 associated with the user on the system 20 and creates the appropriate identifying information that associates the bucket 17 with the user on the device 10. The user on the device 10 is the manager or the managing device for the virtual bucket 17. The system 20 sends information, e.g., the bucket ID, identifying the virtual bucket 17 to the device 10. In an aspect, the bucket ID is provided to the device 10 in the form of a 3D Barcode, although not limited to this form. The user of the sending device 13 takes the device 13 and places it in close enough proximity to device 10 that device 13 can read the virtual bucket ID on the device 10. In an aspect, the bucket ID has sufficient information that is translated by standard features of the device 13 to have the device connect to the system 20 and request information from the virtual bucket 17. The system 20 recognizes the virtual bucket ID and provides the information to the device 13. System 20 then deletes the virtual bucket.

In an aspect, when the data has been received from the virtual bucket 17, the device 13 confirms (with the user) of the computer system 10 that the data should be stored and determines where to store the data or request information from the user. For example, the system identifies what kind of data file has been received and depending on the type of data file, the device 13 saves the data in a particular location. For example, if the data file is identified as data received as a calendar entry for a particular calendar system (e.g., Google, yahoo, etc) on the user's computer system 10 and when approved for storage by the user, the device 13 causes the stores the data in the storage area for that calendar system. Different types of data are generally stored in a location specific for that type of data.

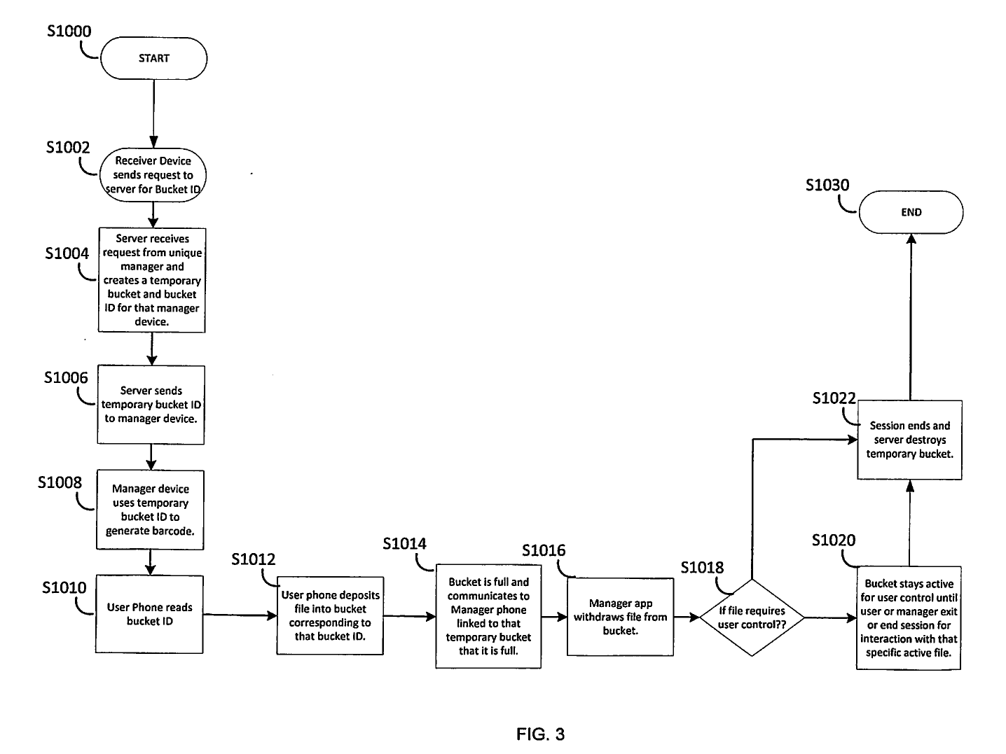

FIG. 3 depicts an exemplary operation of the virtual bucket system of FIG. 2.

In segment S1000, the process flow begins. Process continues to segment S1002.

In segment S1002, a user on a receiving device accesses a virtual bucket website and requests a virtual bucket. Process continues to segment S1004.

In segment S1004, the Server receives request from unique manager (the receiving device) and creates a temporary bucket and bucket ID for that manager device—the receiving device. Information by manager device supplied to server include Manager ID, Device Type, other information about device, rules, and capabilities. Manager ID will be used during active temporary bucket use, to confirm that the device withdrawing from bucket is the only device that can withdraw from that temporary bucket. Manager devices can include Brower on specific PC, TV, Net TV, Google TV, Chromecast, and other devices that can withdraw from bucket. Process continues to segment S1006.

In segment S1006, server sends bucket ID to manager device. Process continues to segment S1008.

In segment S1008, manger device generates bar code based on bucket ID. In another aspect, manager device receives bar code from server. Process continues to segment S1010.

In segment S1010, user on sending device reads bucket ID on receiving device. Process continues to segment S1012.

In segment S1012, user sends file from sending device to virtual bucket based on bucket ID. Process continues to segment S1014.

In segment S1014, server notes that virtual bucket has received and stored data and communicates thus to receiving device. Process continues to segment S1016.

In segment S1016, server sends data in virtual bucket to receiving device. Process continues to segment S1018.

In segment S1018, server determines whether file needs user control as the server knows what type of device the receiving device is. In an approach, when the server connects to the receiving device, the receiving device, when communicating back to the server that it has established a connection, can communicate to it what type of device it is. Example, the receiving device is a TV, Stereo, etc. that can use user commands. As such, the server would enable user controls. In another approach, an initial instruction file deposited in the bucket by either the sender or the receiver, contains instructions indicating to the server, and/or the other party, what type of device it is and what are its capabilities. By knowing the capabilities of the receiving device, the server determines whether the file needs user control and whether the receiving device can receive instructions. In another approach, the server determines whether the file can use user control and whether the receiving device can receive instructions. If so, then process continues to segment S1020. Otherwise, process continues to segment S1022.

In segment S1020,bucket stays active and sending user continues to send data, e.g., control signals, to receiving user. Process continues to segment S1022.

In segment S1022, the session ends and server deletes virtual bucket. Process continues to segment S1024.

In segment S1024, the process ends. The process can be started again.

Thus, a Temporary Bucket ID is held on manager receiving device until session is ended. Upon end of session and confirmation of temporary bucket destroyed, the temporary bucket ID is deleted from the Manager Device.

In another approach, a user manually selects a Virtual Bucket app to run on the computer system 10. In yet another approach, the user touches—places the mobile communication device within sufficient distance of another close proximity device in order to carry out communications—e.g., the computer system 10 to the NFC tag which initiates NFC communications using the inherent NFC capability of the computer system 10 as well as the NFC tag 10.

If the virtual bucket app is not already installed on a computer system 10, a user can download and install it from a public program server, e.g., Apple app store, Google Playstore, Microsoft server. Alternatively, the virtual bucket app is downloaded automatically. In a preferred approach, the mobile communication device's 10 operating system looks for the Virtual Bucket app on the computer system 10, and if it isn't already executing, then using another part of the data received from the other device, the operating system, alone, or in combination with other aspects of the computer system 10, determines where to download the Virtual Bucket app from and causes the Virtual Bucket app to be downloaded, installed and executed on the computer system 10.

In an aspect, the Virtual Bucket app on the computer system 10 uses part of the data received from the NFC tag 11 to determine what to do. For example, the Virtual Bucket app receives communication information providing information on how to communicate with the server 15 to access data in the Virtual bucket 17. For example, the communication information is a URL or web site address of the server 15. The communication information may also contain a preferred communication method for communicating with the server 15. For example, a preferred communication method is the Internet. In an aspect, the communication information includes access information, e.g., a username and password, to access the Virtual Bucket. Thus, using the communication information the Virtual Bucket app causes the computer system 10 to establish communications with the server 15.

In an aspect, the Virtual Bucket app on the computer system 10 uses part of the data received from the NFC tag 11 to identify the appropriate virtual bucket 17 of the server 15. In an aspect, tag 11 stores a unique identifier which is provided to the computer system 10. In turn, computer system 10 provides that unique identifier to the server 15. The server 15 uses the unique identifier to identify which virtual bucket 17.

As noted above, an information source 20 includes a transfer description data source 11, e.g., a tag, and a computer system 13. In a preferred approach, the information source 20 is the source of the electronic data sought to be transferred to the computer system 10. More specifically, the computer system 13 includes the electronic data sought to be transferred to the computer system 10. Although depicted as a single information source 20, single tag 11 and computer system 13, the invention is not so limited, and the system 5 can have a plurality of information sources 20, tags 11, and computers systems 13. Preferably, especially when there is a plurality of tags 11, identifying information stored on a tag 11 uniquely identifies the respective tag 11.

By virtue of the virtual bucket being and the bucked ID being created dynamically, a virtual bucket system allows for enhanced security in at least two different ways: firstly, it reduces the possibility of the Tag being impermissibly cloned, which the computer server uses to know which virtual bucket corresponds to the computer system defined to that Tag. Secondly, by virtue of having a dynamic association, it reduces the probability of a third party impermissibility seeking and accessing the virtual bucket thereby increasing the security of the system. In an aspect, a virtual bucket ID is relatively anonymous and thus increases the security of the system.

In a preferred aspect, transfer description data source 11 includes at least several pieces of data that will be read by a computer system 13 appropriate program designation data, communication data, access data, and identifying data. One piece of data to be read by the computer system 13 is program designation data. This data indicates the appropriate program, e.g., the Virtual Bucket app, that a computer system 10 should be executing to implement data transfer using a Virtual bucket. This data also indicates where the appropriate program can be located, e.g., downloaded from.

In an aspect of the invention, tag 11 includes access information. In certain situations, where increased security protocols are employed, a computer system 10 may require additional information to access and retrieve data in a virtual bucket. For example, the additional information is a password or pass code that is provided to the server 15 to access the data in the virtual bucket. Thus, the computer system 10 reads this information from the tag 11 and provides the access information to the server 15 when the computer system 10 communicates with the server 15 to access the virtual bucket 15. In an aspect, tag 11 includes identifying information. In an aspect, the identifying information identifies the tag 11. The identifying information is, for example, a unique serial number for tag 11. In another aspect, the identifying information is USI. In another aspect, the identifying information is information that reflects a unique association between the tag 11 and a storage location. In an aspect tag 11 executes an application or API of the virtual bucket system on the tag 11 which provides additional features and interactions with the computer system 10.

In an aspect, no dedicated virtual bucket software runs on the device 10 or device 13. However, computer system 20 runs appropriate software to communicate with and provide information to and receive information from sending and receiving devices 10 and 13. Further, computer system 20 runs appropriate software that enables the management of virtual bucket(s), including the creation, deletion and access to, as well as maintain information that correlates a virtual bucket with a sending/receiving device.

In another aspect, a Virtual Bucket software runs in the background or foreground of device 10 and 13 for the system. In an aspect, each of the devices has different hardware and software configuration and therefore an appropriate version of the virtual bucket system will be employed to effectively execute on the hardware/software combination of each device. Once installed and operational, the software essentially runs seamlessly in the background without any or without a significant amount of input/interaction from a user to work, with the notable exception of requiring decision input from a user. Although referred to as software, the invention is not so limited and it may also be referred to as an app, plug-in, module, and other various parts of a computing system. Furthermore, the system can also be implemented in hardware.

The virtual bucket app on the computer system 10 communicates with a predefined server 15 or a central switch board on a server, and uses the tag identifier to link to or be redirected to a computer system's Virtual Bucket 17, which may be on that server with the central switch board, or on a second server/computer system. The information may also be in a specified format in which the virtual bucket system on the Mobile Device can read and/or interpret.

The communication instructions received from tag 11 provide instructions to the computer system 10 directing how the computer system 10 can communicate with server(s) 15 including virtual bucket 17 which corresponds to the account linked to the specific Tag 11 being communicated with. The communication instructions include, for example, URL, IP address, port, login process, application to application communication, api to api communication, and other methods of defining one device to a second device to communicate via electronic means.

While the invention references the use of NFC, other technologies may be substituted general modifications of some capabilities of the invention. It would be obvious to one with skill any modifications that would be necessary. For example, while some descriptions of exemplary embodiments of the invention are described with respect to the use of NFC technologies, other close proximity communications technologies can be substituted include, but are not limited to Barcodes (2D, 3D, and otherwise), Bluetooth and Bluetooth beacons, Wi-Fi, LED lights, etc. While the invention discloses an NFC Tag, an NFC Device can also be used such as an NFC Reader which is stand alone, connected to another computer system, or able to communicate with the server(s) or computer system(s) via network connection. In another approach, if communication method other than NFC is being employed, then an appropriate corresponding device is employed in place of an NFC tag. In an aspect, the server 15 is a separate computer system from computer system 13. In other aspects, the server 15 is the same as or an associated computer system with computer system 13.

In another exemplary approach, a virtual bucket system is employed as a “middle device intelligence,” a bridge device, to enable communications between a first communication system and an second communication system, e.g., between a server and another computer system. A virtual bucket is a substantially “blind” middle point to provide temporary, substantially instant access and sharing between two devices.

Some communication situations require a middle intelligence to process the connection, communication, interpretation of data, and action of the receiving device. For example, a personal computer acts as the middle intelligence between a server and a printer. In an aspect of the invention a Smart Phone as the middle intelligence between the server and a another device, e.g., a Smart TV.

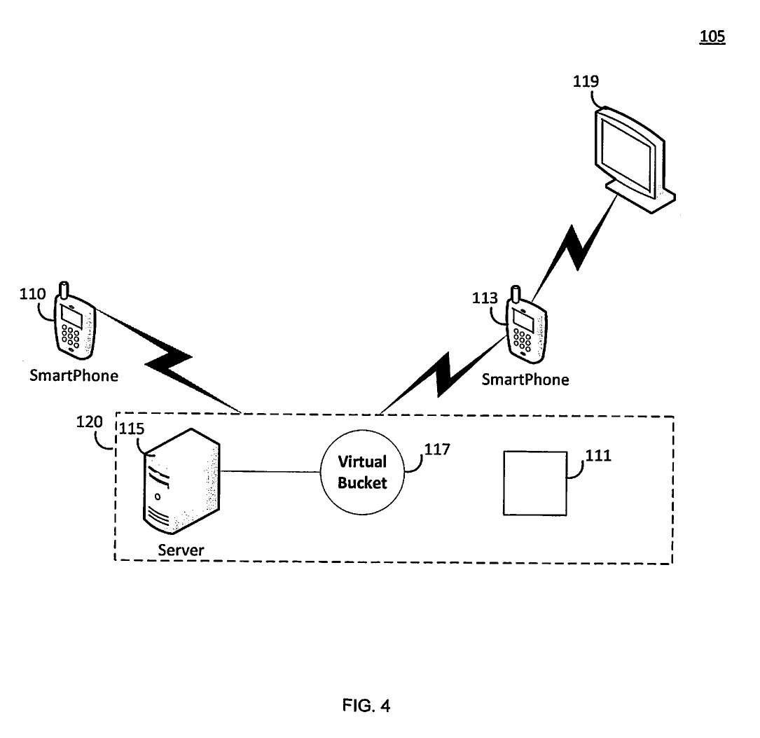

In another aspect, as depicted in FIG. 4, the receiving device is a smart device 119, but uses a bridge or intermediary device 113 to receive the file from device 110.

FIG. 4 depicts a virtual bucket system 15 incorporating a middle intelligence system. The system 15 includes a first and second computing system 110, 113, a receiving device 119, and a computing system 120, which includes a computer server 115 and a virtual bucket 117 as part of the server 115.

In a general overview, a computer system 110 indirectly provides data to a receiving device 119. The computer system 110 provides data to the computer system 120, whereby the data is stored in a virtual bucket within the server 115 of the computer system 120. The computer system 120 provides the information to the smart phone 113. Smart phone 113 establishes communications to the receiving device 119. The smart phone 113 receives information from the virtual bucket and provides it to the receiving device 119. In a preferred approach, Device 113 and receiving device 119 communicate through a Wi-Fi communication system using known communication methods. One method of the device 113 communicating with the device 119 is similar to the method used by when devices communicate through the Wi-Fi, for example, a computer connected to a Wi-Fi system and a printer also connected to the same Wi-Fi system. Other approaches have the device 113 and device 119 communicating using other appropriate communication methods.

In an aspect an exemplary computer system, preferably a mobile communication device, e.g., a Smartphone, contains an application, api, web app, web service, os service, or other additional hardware or software which preferably has at least two purposes: A first purpose is to be a secure data bridge between the virtual bucket and the receiving device. A second purpose is to be the intelligence where by all security and communication measures, file interpretation and processing, as well as action and intents are initiated, (partially or fully) processed, and/or causes the other devices to perform these and/or other collateral tasks.

With respect to the first purpose, the Smartphone uses standard, conventional communication methods to connect to the internet or via wired/wireless communication to a server or device running the bucket system. This can be communicated to depending on the circumstance, need, and distance of the virtual bucket system. Therefore the SmartPhone can use cellular, Wi-Fi, Bluetooth, NFC, or other wired/wireless communication methods.

The second purpose reflects that the Smartphone is responsible for the security such as inputting passwords, passing tokens, maintaining a VPN, ssl, https, or other security measures for network communication. The file interpretation processing can include but are not limited to converting the file, compressing or uncompressing the file, modifying the file to work better on the receiving device, or other possible methods of recognizing, changing, manipulating, adding, combining or editing the file. For example, the phone can receive five photos zipped at 640×480 resolution from the bucket. The phone will deliver these photos to be shown on the TV. Before transferring the photos received from the bucket to the TV, the phone can unzip the files, then resize them to optimal sizing such as the standard 1920×1080 resolution of a standard HDTV. The phone can also rename the files to better process them in a slideshow. The phone can convert the files from png to jpeg if a specific TV can only show jpeg and the files received start as png. The phone can modify the files to whatever requirements would best allow the files to be accessed or used by the receiving device. Other examples include changing, modifying, or transcoding video/audio.

The Smartphone can also be the access point for user interaction where the phone's touch screen and keypad can be used more easily to input requests or information from a user compared to a TV or its standard remote. This also allows the phone to be the intelligence for interacting with a remotely located website, web service, or web app. These interactions and others like it are considered actions or intents. This method and the examples above could be expanded to any device which can receive the files or actions such as a Tablet, Monitor, a second smart phone, a smart watch, or other devices.

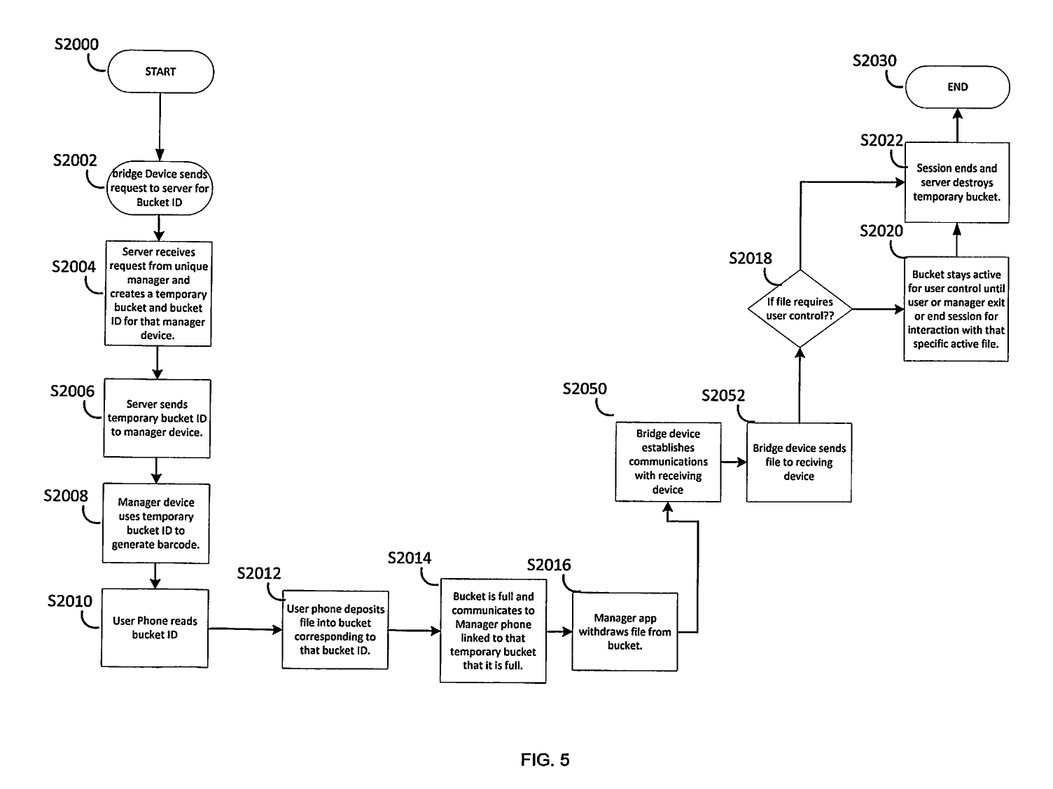

FIG. 5 depicts an exemplary operation of the virtual bucket system of FIG. 4.

In segment S2000, the process flow begins. Process continues to segment S2002.

In segment S2002, a user on a bridge device accesses a virtual bucket website and requests a virtual bucket. Process continues to segment S2004.

In segment S2004, the Server receives request from unique manager (the receiving device) and creates a temporary bucket and bucket ID for that manager device—the bridge device. Information by manager device supplied to server include Manager ID, Device Type, other information about device, rules, and capabilities. Manager ID will be used during active temporary bucket use, to confirm that the device withdrawing from bucket is the only device that can withdraw from that temporary bucket. Manager devices can include Brower on specific PC, TV, Net TV, Google TV, Chromecast, and other devices that can withdraw from bucket. Process continues to segment S2006.

In segment S2006, server sends bucket ID to manager device. Process continues to segment S2008.

In segment S2008, manger device generates bar code based on bucket ID. In another aspect, manager device receives bar code from server. Process continues to segment S2010.

In segment S2010, user on sending device reads bucket ID on bridge device. Process continues to segment S2012.

In segment S2012, user sends file from sending device to virtual bucket based on bucket ID. Process continues to segment S2014.

In segment S2014, server notes that virtual bucket has received and stored data and communicates thus to bridge device. Process continues to segment S2016.

In segment S2016, server sends data in virtual bucket to bridge device. Process continues to segment S2018.

In segment S2050, the bridge device establishes a communication connection to a receiving device, if it has not already done so. Process continues to segment S2052.

In segment S2052, the bridge device sends the data to the receiving device. Process continues to segment S2018.

In segment S2018, server determines whether file needs user control as the server knows what type of device the receiving device is. In an approach, when the server connects to the receiving device, the receiving device, when communicating back to the server that it has established a connection, can communicate to it what type of device it is. Example, the receiving device is a TV, Stereo, etc. that can use user commands. As such, the server would enable user controls. In another approach, an initial instruction file deposited in the bucket by either the sender or the receiver, contains instructions indicating to the server, and/or the other party, what type of device it is and what are its capabilities. By knowing the capabilities of the receiving device, the server determines whether the file needs user control and whether the receiving device can receive instructions. In another approach, the server determines whether the file can use user control and whether the receiving device can receive instructions. If so, then process continues to segment S2020. Otherwise, process continues to segment S2022.

In segment S2020,bucket stays active and sending user continues to send data, e.g., control signals, to receiving user. Process continues to segment S2022.

In segment S2022, the session ends and server deletes virtual bucket. Process continues to segment S2024.

In segment S2024, the process ends. The process can be started again.

Thus, a Temporary Bucket ID is held on manager receiving device until session is ended. Upon end of session and confirmation of temporary bucket destroyed, the temporary bucket ID is deleted from the Manager Device.

Thus in an exemplary operation. A first user, user A, is visiting the home of a second user, user B. User B's home has a stereo system which is accessible through a communication method, e.g., Wi-Fi. User A can send information from his phone, e.g., stream a radio station from his phone's cellular connection, to User B's phone, and from User B's phone to a Virtual bucket, and from the Virtual bucket to User B's stereo. Consequently, user A's phone uses the bridge capability of the virtual bucket system to give the stereo access not only to the bucket system via User A's phone, but also as a bridge to then take the information being accessed via the bucket, back to the stereo of user B.

In another aspect, User A's phone interface can provide an intelligence interface in this case, thereby becoming the remote control for that stereo. Thus, User A provides commands which are communicated to User B's phone. User B's phone sends the commands to the virtual bucket and then the virtual bucket provides those commands to the stereo.

In another exemplary approach, the phone is the middle intelligence as well as running the bucket system as in the example before defined. The phone can be the access point for the receiving device to communicate to the bucket system, and it can be the intelligence such as controlling the content being accessed by the receiving device. Example, streaming a radio station as well as controlling playback such as play, pause, fast forward, reverse, etc. For example, smart phone for User A communicates with a smart TV through the same Wi-Fi network that the smart TV is connected to. User B's phone can communicate to User A's phone via non-internet methods such as using Wi-Fi, Bluetooth, NFC, sonic, barcode, or other methods of communication that both User A's device and User B's device have that communication method available to them. User A's device does not have to be limited to a phone and can be any device that User A has, such as a computer in their home, communicating to any User A device such as a Smart TV, where User A's device acts as the bridge to the receiver device as well as running the bucket system on User A's bridge device. And User B can communicate to the bucket system by multiple communication methods.

Thus in an exemplary operation, User A visit User B's office and wishes to print something on User B's printer. User B does not want User A to have access to User B's Wi-Fi connection, which is what User B's printer is connected to. So User Buses the bucket system where User A's phone which has the file to be printed, communicates the file through a virtual bucket to User B's phone, which in turn communicates the file to User B's printer. In an aspect, this process is more than a file transfer, this process enables User A to communicate controls to User B's printer. For example, user A provides printer control commands such as what size, how many copies, color or black and white, etc. Thus, User B's phone which has secure access to his printer, can be the bridge between User B's printer and User A's phone, to allow User A to print and control User B's printer via User A's phone's interface, but communicating it all securely and privately via the bucket system through B's phone.

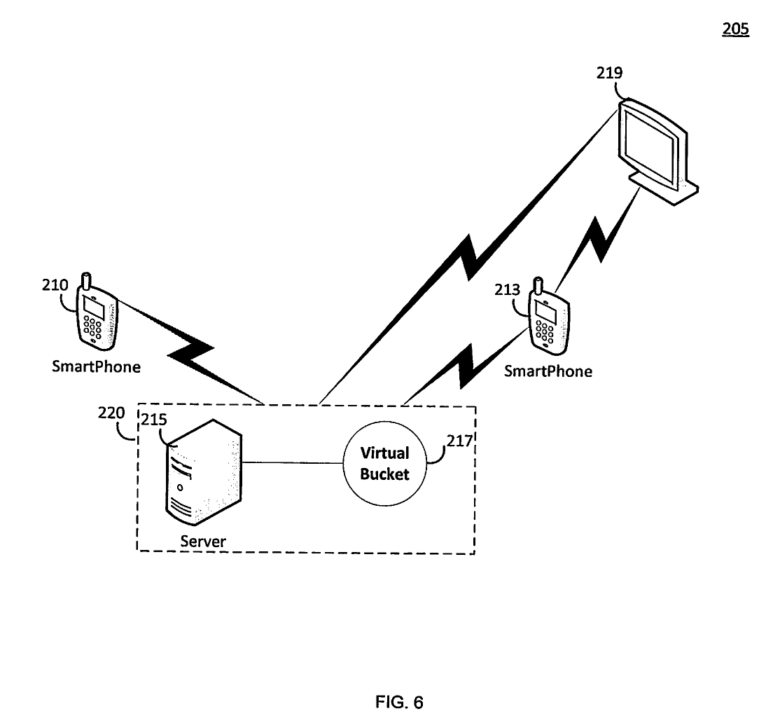

In another exemplary approach, generally referred to as Zero Access login, a virtual bucket system is used to maintain anonymity and offer instant temporary buckets between two parties. FIG. 6 depicts a zero access login system, which includes a first computing system 210, a receiving device 219, and a computing system 220, which includes a computer server 215 and a virtual bucket 217 as part of the server 215. In aspect the system includes a second computing system 213 to act as a bridge device to bridge communications between the system 220 and the receiving device 219. In a different aspect, the receiving device communicates with the system 220 without a bridge device.

In a general overview, a computer system 210 indirectly provides data to a receiving device 219. The computer system 210 provides data to the computer system 220, whereby the data is stored in a virtual bucket within the server 215 of the computer system 220. The computer system 220 provides the information to the smart phone 213. In one aspect, Smart phone 213 establishes communications to the receiving device 219. The smart phone 213 receives information from the virtual bucket and provides it to the receiving device 219. In another aspect, the system 220 establishes communications with receiving device 219.

For example, a first user wishes to share a photo on the TV of second user. The second user could run a webpage with a web app or service or can run an application which will receive the file onto the TV that the first user sends. Traditionally, to know where to send a withdrawn file, a server would require the second user to put in a username/password so that the server knows which location to send the withdrawn photo from the bucket. Using Zero Access Login, the server will generate a temporary bucket for this transaction. The TV will be activated and request the server to generate a temporary bucket and bucket ID to be used for one transaction of transferring files or information. This bucket ID could for example be 12345’. The server also creates a temporary bucket for that bucket ID. That bucket ID is then sent to the receiving device. Then the unique temporary ID is broadcast via any method of communication including but not limited to Bluetooth, Wi-Fi, Sonic, Barcode, NFC, and other methods of communication possible by the receiving device. This broadcast of this ID is received by device 210. Then device 210 uses this information and communicates with the server 220.

The server recognizes this ID as being a temporary ID for which is linked to a temporary bucket. Then the server 220 receives the photo file and deposits it in the temporary bucket. Device 219 was the one that requested the temporary bucket and broadcast it to device 210. Therefore device 210 can use that ID to communicate to the server 215 to request to deposit the file from the temporary bucket. As well, since the server 215 knows that device 219 requested the temporary bucket originally, then the server 215 can communicate back to device 219 when the temporary bucket is filled. There are other methods of informing Once device 213 withdraws the file from the temporary bucket 217 of server 215, the temporary bucket is destroyed (erased) and, in some aspects, can never be used again. If another person or the same person wishes to share another file or information with device 219, then the process begins again, creating another temporary bucket and/or bucket ID, to be used for that one time exchange of depositing and withdrawing from the temporary bucket created for that one exchange event. Ideally, the new bucket and bucket ID are different from the old bucket and bucket ID.

In another aspect, when a device 213 is used as a bridge device between device 219 and computer system 220, and a first user wishes to share a photo on the TV of second user. The second user could run a webpage with a web app or service or can run an application which will receive the file onto the TV that the first user sends. Traditionally, to know where to send a withdrawn file, a server would require the second user to put in a username/password so that the server knows which location to send the withdrawn photo from the bucket. Using Zero Access Login, the server will generate a temporary bucket for this transaction. The intelligence connected to the TV, i.e., device 213 will be activated and request the server to generate a temporary bucket and bucket ID to be used for one transaction of transferring files or information. This bucket ID could for example be 12345’. The server also creates a temporary bucket for that bucket ID. That bucket ID is then sent to the device's intelligence bridge device 213. Then the unique temporary ID is broadcast via any method of communication including but not limited to Bluetooth, Wi-Fi, Sonic, Barcode, NFC, and other methods of communication possible by the bridge intelligence. This broadcast of this ID is received by device 210. Then device 210 uses this information and communicates with the server 220.

The server recognizes this ID as being a temporary ID for a its bridge intelligence which is linked to a temporary bucket. Then the server receives the photo file and deposits it in the temporary bucket. Device 213 was the one that requested the temporary bucket and broadcasts it to device 210. Therefore device 210 can use that ID to communicate to the server 215 to request to deposit the file from the temporary bucket. As well, since the server 215 knows that device 213 requested the temporary bucket originally, then the server 215 can communicate back to device 213 when the temporary bucket is filled. Once the device 213 receiving the indication that there is information to be collected from a virtual bucket, device 213 withdraws the file from the temporary bucket 217 of server 215, the temporary bucket is destroyed (erased) and, in some aspects, can never be used again. Then device 213 communicates this information to device 219 If another person or the same person wishes to share another file or information with device 219, then the process begins again, creating another temporary bucket and/or bucket ID, to be used for that one time exchange of depositing and withdrawing from the temporary bucket created for that one exchange event. Ideally, the new bucket and bucket ID are different from the old bucket and bucket ID.

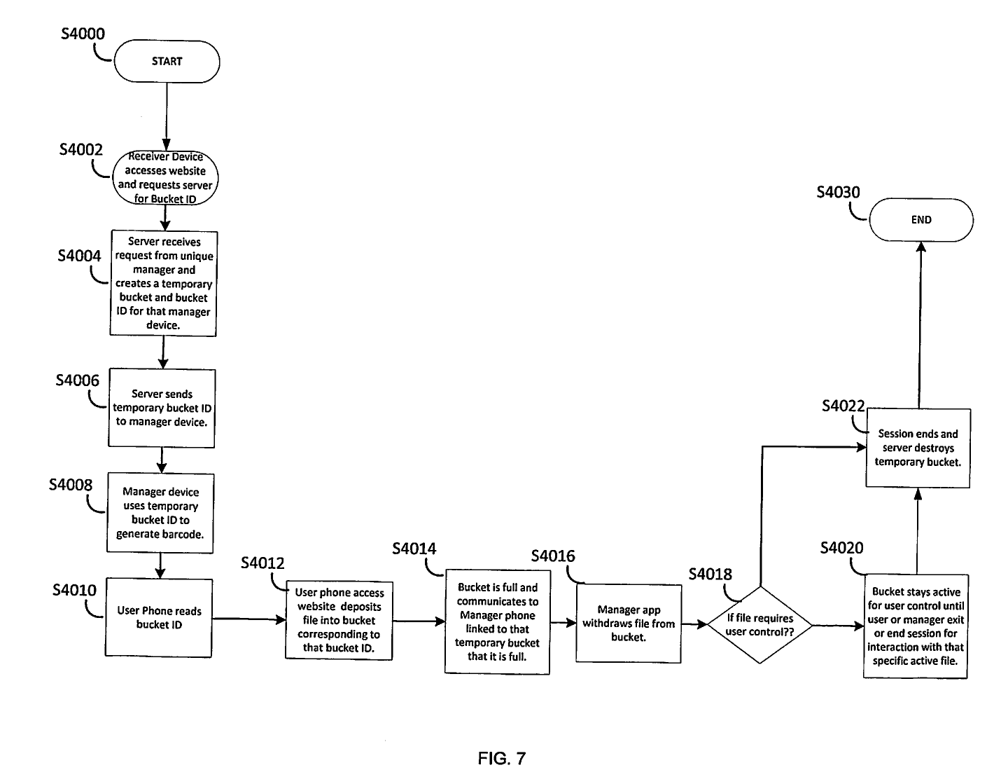

This method allows for substantial anonymity between the two parties and removes any requirement for the need of traditional authentication such as passwords. This is not a temporary point to point approach because the bucket acts as a middle bridge, so no true direct connection between the first device and the receiving device is created. The temporary bucket substantially acts as a blind middle (e.g., a “straw man), and when no longer used, is wiped from existence and, in an aspect, can never be created again exactly again, unless the process is re-initiated. This method can also be used dynamically where multiple files or data can be sent sequentially and for each file(s) or request(s) sent, a new bucket is created. In this case, every deposit and withdrawal creates a new bucket, but at a high speed of creation and deletion. This creates a constant randomness as to the connection of transfer of files or data. Though the example points to a user sharing a photo via a smart phone to a second users TV, this process can be used in any number of other exchanges of information and requests. An exemplary process flow is depicted in FIG. 7:

In segment S4000, the process flow begins. Process continues to segment S4002.

In segment S4002, a user on a receiving device accesses a virtual bucket website and requests a virtual bucket. Process continues to segment S4004.

In segment S4004, the Server receives request from unique manager (the receiving device) and creates a temporary bucket and bucket ID for that manager device—the receiving device. Information by manager device supplied to server include Manager ID, Device Type, other information about device, rules, and capabilities. Manager ID will be used during active temporary bucket use, to confirm that the device withdrawing from bucket is the only device that can withdraw from that temporary bucket. Manager devices can include Brower on specific PC, TV, Net TV, Google TV, Chromecast, and other devices that can withdraw from bucket. Process continues to segment S4006.

In segment S4006, server sends bucket ID to manager device. Process continues to segment S4008.

In segment S4008, manger device generates bar code based on bucket ID. In another aspect, manager device receives bar code from server. Process continues to segment S4010.

In segment S4010, user on sending device reads bucket ID on receiving device. Process continues to segment S4012.

In segment S4012, in an aspect the on the sending device creates a portal to the third computer system and ends file from sending device to virtual bucket based on bucket ID. Process continues to segment S4014.

In segment S4014, server notes that virtual bucket has received and stored data and communicates thus to receiving device. Process continues to segment S4016.

In segment S4016, server sends data in virtual bucket to receiving device. Process continues to segment S4018.

In segment S4018, server determines whether file needs user control as the server knows what type of device the receiving device is. In an approach, when the server connects to the receiving device, the receiving device, when communicating back to the server that it has established a connection, can communicate to it what type of device it is. Example, the receiving device is a TV, Stereo, etc. that can use user commands. As such, the server would enable user controls. In another approach, an initial instruction file deposited in the bucket by either the sender or the receiver, contains instructions indicating to the server, and/or the other party, what type of device it is and what are its capabilities. By knowing the capabilities of the receiving device, the server determines whether the file needs user control and whether the receiving device can receive instructions. In another approach, the server determines whether the file can use user control and whether the receiving device can receive instructions. If so, then process continues to segment S4020. Otherwise, process continues to segment S4022.

In segment S4020,bucket stays active and sending user continues to send data, e.g., control signals, to receiving user. Process continues to segment S4022.

In segment S4022, the session ends and server deletes virtual bucket. Process continues to segment S4024.

In segment S4024, the process ends. The process can be started again.

Thus, a Temporary Bucket ID is held on manager receiving device until session is ended. Upon end of session and confirmation of temporary bucket destroyed, the temporary bucket ID is deleted from the Manager Device.

Thus, in an example approach, to display a file from a user's Smartphone on a PC or smart TV:
1. A first user goes on the Internet to the specific site, e.g., vbukit.tv, on her receiving device, e.g., a pc or TV browser. The receiving device displays a virtual bucket identifier, e.g., a bar code, on the display of the receiving device.
2. On her Smartphone, she opens Vbukit app, a program for interacting with the virtual bucket.
3. Using her Smartphone, she scans the display of the receiving device, e.g., barcode, representing virtual bucket location. The Smartphone determines the server from the virtual bucket information and the server can determine the virtual bucket for the receiving device based on the virtual bucket identifier.
4. On her Smartphone, on the Vbukit app, she selects ‘Send Files’.
5. On her Smartphone, on the Vbukit app, she selects ‘Send Photos’
6. On her Smartphone, on the Vbukit app, she selects a photo or photos, e.g., a jpeg file, to be sent. In an aspect, only one photo (or file) is selected. In another aspect multiple photos (or files) are selected.
7. The Vbukit app on the Smart phone sends the file to the server and the server places the file in the virtual bucket that has been identified.
8. The receiving device retrieves the file from the virtual bucket. The receiving device determines the appropriate file type and takes the appropriate action. For example, it receiving device identifies the file as a photo, as it is a jpeg, and displays the photo. In an aspect, the file is downloaded to the receiving device. In another aspect, the file remains on the virtual bucket and the receiving device displays the contents of virtual bucket.
9. Photo will appear on screen of the receiving device.
10. In an aspect, user controls will appear on the first user's phone's screen. For example, these user controls for the example of a photo are commands to enable zooming in and zooming out. If the information conveyed is a slideshow of photos the commands are controls for the slide show to proceed to a next or previous image in the slide show.
11. When done, the first user selects a command to complete the process on her Smartphone
12. The receiving device stops the display of the file and returns to a go back to the barcode home screen of the portal.

Thus, a temporary Bucket ID is held on a manager receiving device until session is ended. Upon end of session and confirmation of temporary bucket destroyed, the temporary bucket ID is deleted from the Manager Device.

In an aspect, of the above example, a bridge device is employed to provide communications between the virtual bucket and the receiving device. Thus, a temporary Bucket ID is held on a manager bridge device until session is ended. Upon end of session and confirmation of temporary bucket destroyed, the temporary bucket ID is deleted from the Manager Device.

In another exemplary application of a virtual bucket system can be referred to as User control (e.g., UI), a virtual bucket allows for a user control interface that allows for substantially complete anonymity, security, and restricted interaction with a receiving device. For example, User A has a TV. User B has ten (10) vacation photos they wish to show on User A's TV. User A's TV uses the virtual bucket system. User B sends the 10 photos to the bucket which is linked to User A's TV. User A's TV withdraws the 10 photos from the bucket. User B can stay linked to User A's TV bucket while the Photos are actively being shown. Because the virtual bucket system knows the system knows what is file types are being deposited into the bucket. If it's a video file, if it's a single photo, if its multiple photos, if it's a user command, etc. in the case of this example, it knows it's more than one jpeg file which means that its slideshow situation. these are a grouping of photos, the system will then activate on the screen of User B a unique UI for the circumstance, file type, or need to interact with the file or files that User B deposited and that can be controlled on User A's device. In this case, the ten photos can represent a use case for User B to do a slideshow. The UI on User B's phone would show buttons for next, previous, and exit. If user B presses the next button, a request for next is sent to the actively linked bucket. User A's TV is also actively linked to the bucket. If User A's TV sees a request deposited in the bucket, then it will interpret that request and take action based on this request. In this example, the request deposited by User B was next. Therefore User A's TV will show the next photo in the slide show. As soon as User A or B exit, block, or kill the bucket connection, then User B's ability to control is gone and the UI for that specific user control connection is removed from the screen of User B's phone. User A can also define limits or restrictions onto the user control abilities of User B. For example, User B can send a video onto User A's TV. User A's TV can allow for three types of control, being play, pause, and volume. User A can define that User B can only access controls for play and pause but restrict the ability for User B to control volume.

In a preferred approach, a UI Control interface has at least three key points.
1. Both parties can cut off control at any time during the active session by restrictions, limitations, specific action, or by ending the active session.
2. The requests are access based on the dynamic usage of deposit/withdrawal from the bucket currently linked to User's A and B.
3. UI Controls shown on User A and B's devices can be defined by User A and are automatically interpreted and generated based on the specific needs, restrictions, and capabilities of the file type, service, application, or capabilities of the receiving device. So a video file would show play and pause buttons on User B's screen while a slideshow would show next and previous buttons on User B's screen.

The bucket knows both parties, both devices, any rules or restrictions, the file or data type, the abilities of both devices, the abilities and limitations of who to interact or interpret the file or data shared between both devices. Using this information and other such information, the system can dynamically generate unique UI controls on both the sending and receiving devices actively linked to the bucket.

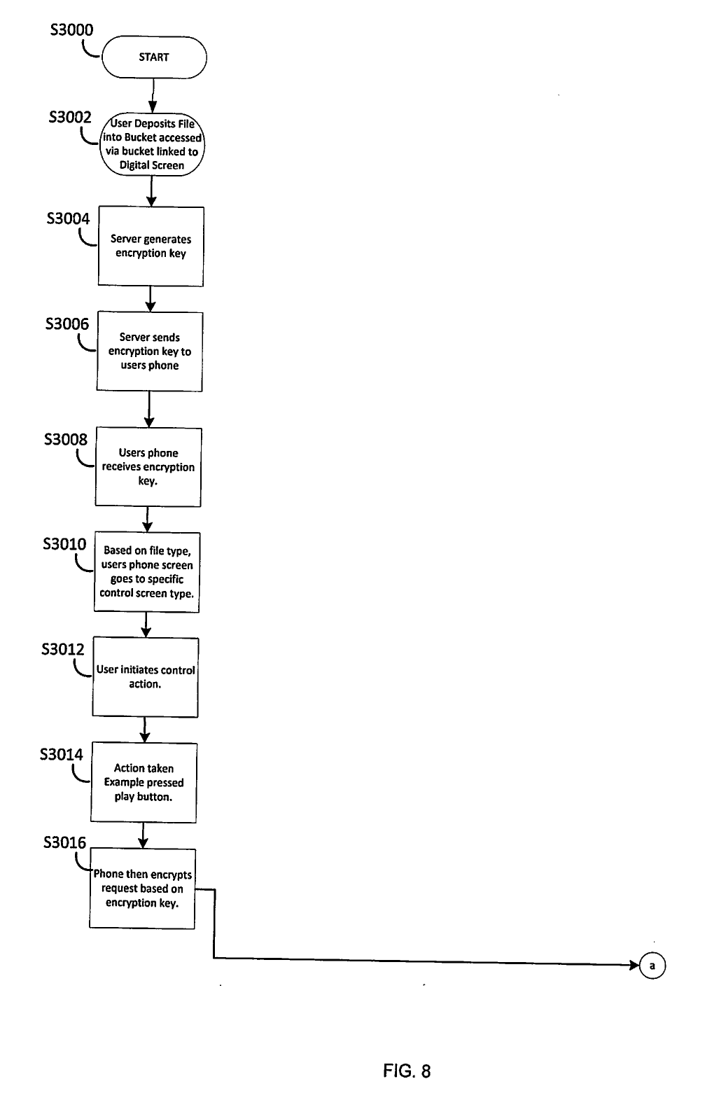

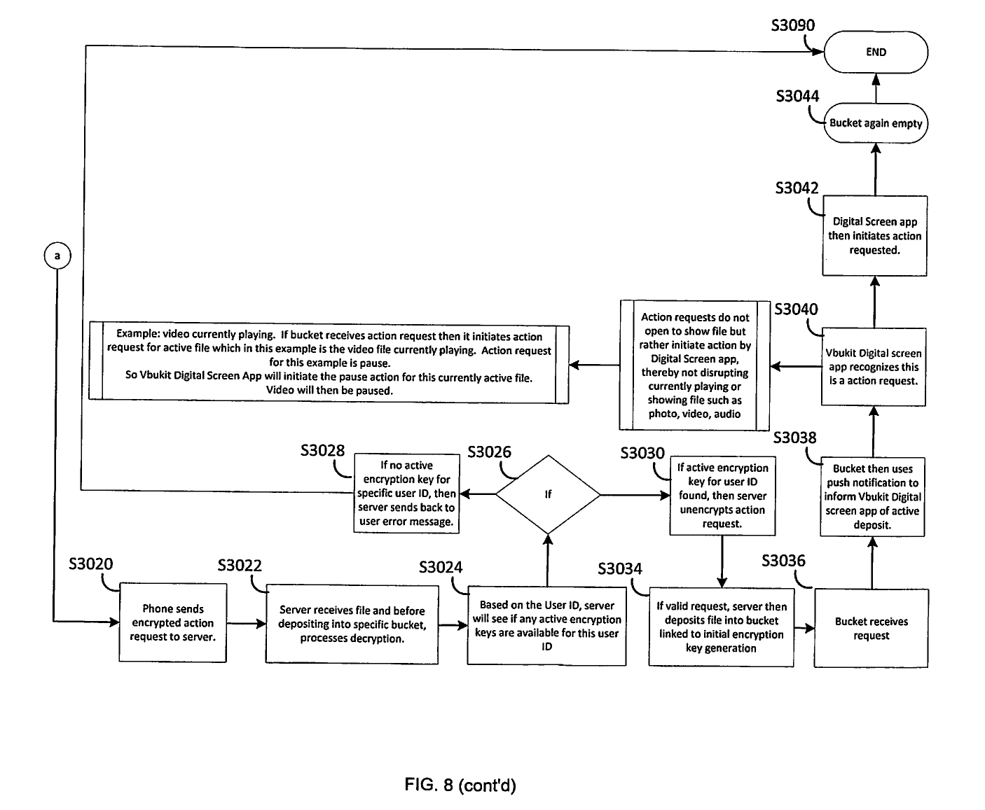

See exemplary process flow depicted in FIG. 8. In a system with Encryption, there are preferred rules of operation: Rules for encryption key active state: (Encryption Keys when changed to NOT Active state, are deleted from sever) 1. If current users current deposit is still being viewed by digital screen app connected to currently deposited bucket=Encryption Key Active. 2. If Vbukit Digital Screen App has closed=Encryption Key NOT Active. 3. If Vbukit Digital Screen App has moved to Deposit Screen=Encryption Key NOT Active. 4. If NEW User deposits new file into current bucket linked to currently Active Encryption Key=Encryption Key Not Active. Server only holds Active Keys and references them to which User ID and which Bucket ID they are linked to. When Key is no longer Active, Server deletes Key and reference information linked to that key from the action control system database. Let's say I'm in your home and I'm streaming and controlling a slideshow on your TV. The communication between your TV and my phone is encrypted based on that sessions encryption between me and your TV. Your TV has an app or using a web app via browser, to securely show and allow control between only my phone and your TV. When you close the TV app or web browser web app, then the server is informed if the connection is ended. That makes the key for that session inactive because one or both parties have ended communication. This makes certain that a new encryption key will be required for another session of communication and interaction between the two devices.

Process begins with segment S3000. Process continues to segment S3002.

In segment S3002, user deposits file into virtual bucket accessed via a bucket linked to digital screen. Phone app and server know that files was deposited based on Vbukit Digital Screen app (example deposited by scan from Vbukit TV). Process continues to segment S3004.

In segment S3004, the server generates encryption key. They key is setup in a gateway temporary data base. It will be referenced based on the User ID of phone and linked to the Bucket ID of the bucket being deposited to. Process continues to segment S3006.

In segment S3006, the server sends encryption key to user's phone. During deposit, server knows which user deposited a file into which bucket based on User ID. Process continues to segment S3008.

In segment S3008, user's phone receives encryption key. Phone app knows this key is to be used for action controls to a bucket for a specific file type. Key kept and used by phone for as long as key is active or as long as user has app open and key is active. Key is deleted if phone receives message key is inactive or if user closes phone app. Process continues to segment S3010.

In segment S3010, based on filed type, user's phone screen goes to specific control screen type. During deposit, users phone app knows what file type it is depositing. Process continues to segment S3012.

In segment S3012, user initiates control action. For example, for a video actions include: play, pause, home screen, etc. Process continues to segment S3014.

In segment S3014, the action is carried out. Process continues to segment S3016.

In segment S3016 the phone encrypts request based on encryption key. Process continues to segment S3020.

In segment S3020, the phone sends encrypted action request to server. The phone also sends the unique phone id of user. Process continues to segment S3022.

In segment S3022, the server receives the file and process decryption before depositing it into specific bucket. Process continues to segment S3024.

In segment S3024, based on the user ID sever will if any active encryption keys are available for this user ID. Process continues to segment S3026.

In segment S3026, if there are encryption keys, then process continues to segment S3030. If not, then process continues to segment S3028.

In segment S3028, if no active encryption key then server sends error message and process continues to segment S3090.

In segment S3030, the server unencrypts action request. Process continues to segment S3034.

In segment S3034, if request is valid, then server deposits file into bucket linked to initial encryption key generation. Process continues to segment S3036.

In segment S3036, bucket receives request. Process continues to segment S3038.

In segment S3038, bucket, using push notification of file deposit. Process continues to segment S3040.

In segment S3040, device recognizes this as an action request. Action requests do not open to show file but rather initiate action by Digital Screen app, thereby not disrupting currently playing or showing file such as photo, video, audio. Example: video currently playing. If bucket receives action request then it initiates action request for active file which in this example is the video file currently playing. Action request for this example is pause. So Vbukit Digital Screen App will initiate the pause action for this currently active file. Video will then be paused. Process continues to segment S3042.

In segment S3042, app initiates app requested. Process continues to segment S3044.

In segment S3044, the bucket is empty. Process continues to segment S3090.

In segment S3090, the process ends.

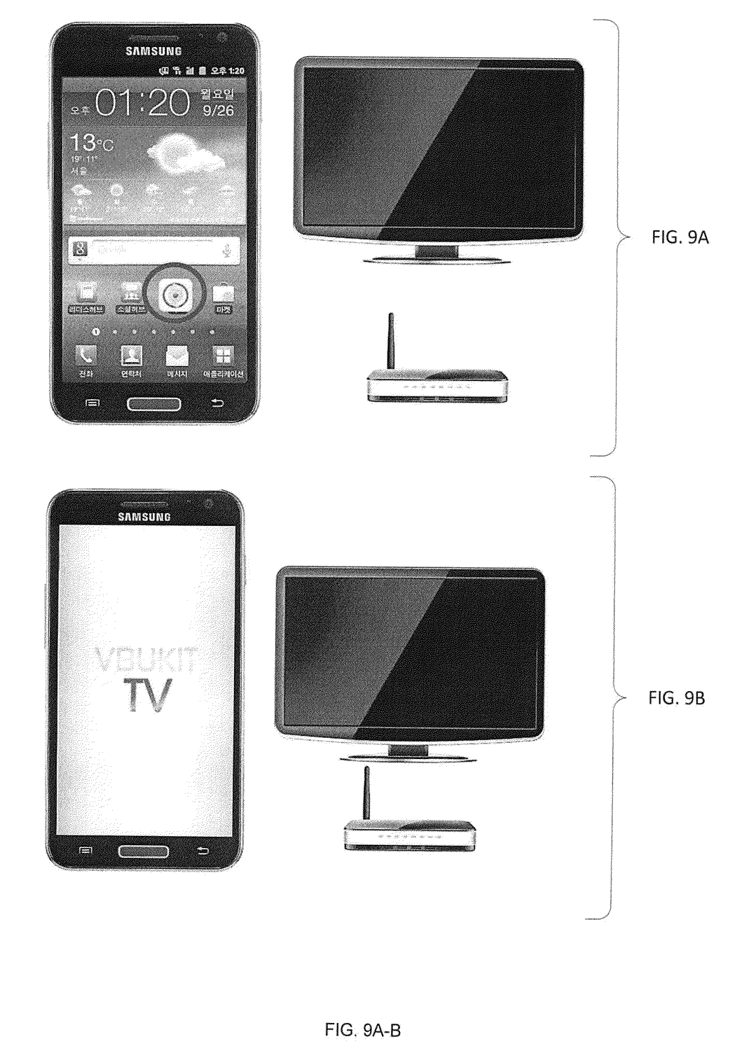

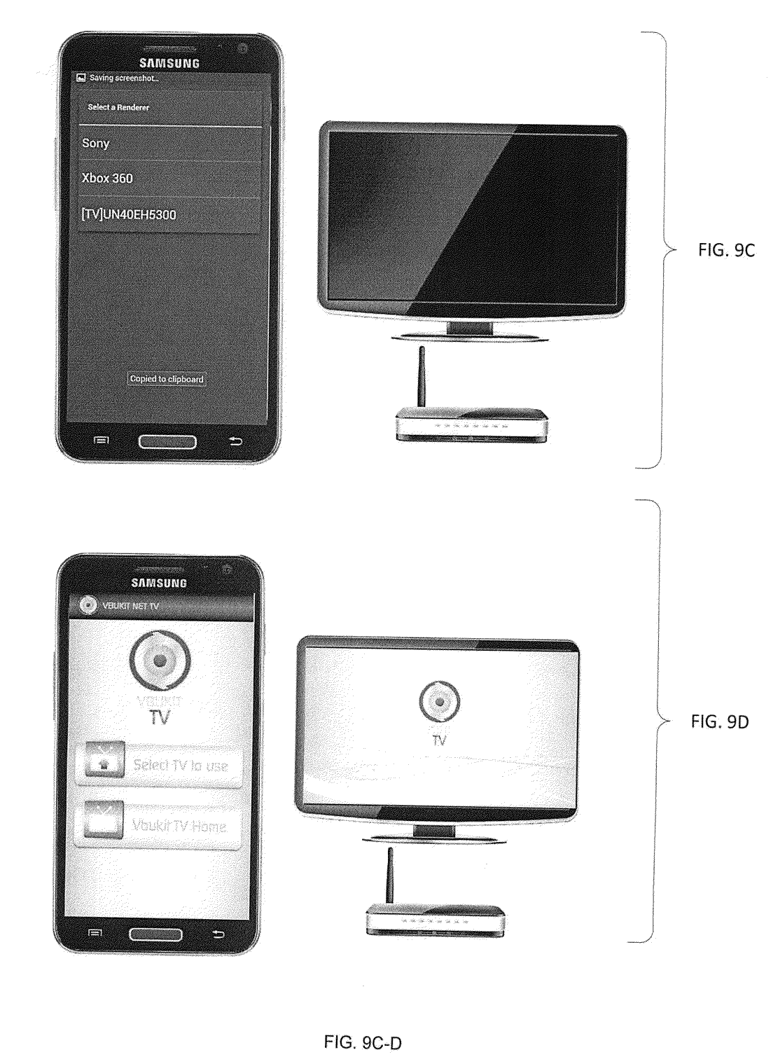

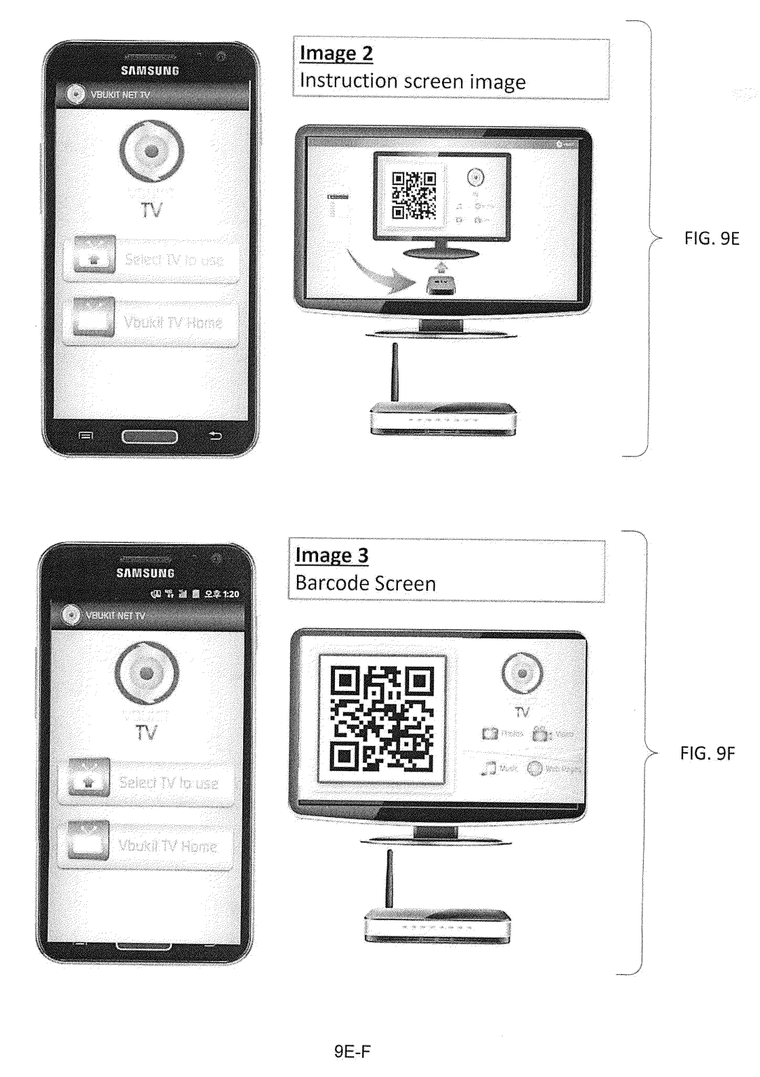

FIGS. 9A-F depict a virtual bucket start up process on a Wi-Fi system. In this application, could use other methods such as Bluetooth, etc. a communication channel of some standard type.

FIG. 9A depicts User B having a virtual bucket application on their phone.

FIG. 9B depicts User B having selected the virtual bucket application on their phone and the application beginning to execute.

FIG. 9C depicts the virtual bucket on User B's phone having connected to the local Wi-Fi system and determines devices that are connect to Wi-Fi system. The Virtual bucket system displays the other devices to the User B as options of devices to be connected to. For example, User B's phone is on the same Wi-Fi network as User B's TV. User B's phone sees all the TV's on that Wi-Fi network.

FIG. 9D depicts that User B has selected the TV on the Wi-Fi network they wish their phone to act as a bridge device for. As a result, User B's phone becomes linked.

FIG. 9E depicts that once User B's phone and TV are linked, user B's phone communicates to the virtual bucket server indicating that it is requesting a bucket ID for a TV it is connected to, to give access to another device to that TV.

FIG. 9F depicts User B's phone downloads from the server a bucket ID and then generates a barcode image based on that bucket ID and sends that image to the TV screen.

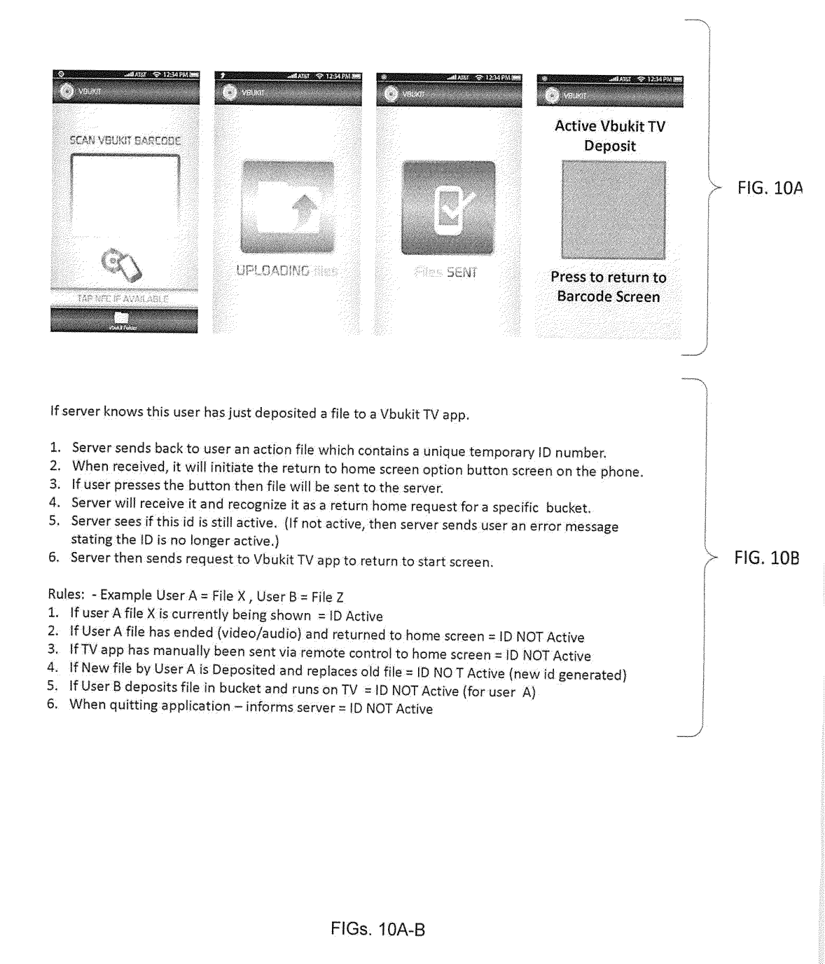

FIGS. 10 A-B depict virtual bucket user control process.

A. depicts a graphical example of the process of scanning a bucket ID from a receiving device, then uploading it to the bucket server and interpreting the user control interface to show on the phone screen of the user depositing a file into that bucket.

B. Show the logical process and rules that define how to link, secure, interact, and use the basic user control system.

Any technology that can uniquely define a specific physical point within a defined area and distance radius, can be used to be the correlations factor for relay to the second parties device as to which bucket it needs to communicate to. While most other technologies may not be as secure or automatic as NFC, they can be used with interacting with the virtual bucket system. For example, the iPhone currently does not have NFC, but the system could use low power Bluetooth to offer similar functionality for the iPhone when interacting with the virtual bucket. Or the system can use 2D barcodes and incorporated a dynamic barcode that constantly changes that is linked to a specific bucket, using the method defined above for dynamic bucket ID's.

The computer system can also have a coupled connection such as an NFC reader connected via USB or a Bluetooth stick connected via USB, to the first party's computer system, or a monitor that can display changing barcodes. These technologies and others which are coupled to the computer system can offer two capabilities in processing and interaction with the virtual bucket.

The first is offering the dynamic unique identifier but with more power and processing capabilities that an uncoupled device. The second is that the coupled device can also be a different channel for allowing the second party device to communicate with the virtual bucket. While the invention defines the mobile device using wired or wireless connection to communicate with the virtual bucket which is independent of the computer system of the first party, the invention should not be limited to this. The mobile device of the second party can use a coupled channel of the first party device to communicate with the first party's virtual bucket which can be held remotely or within the first party's computer system. For example the second party can use peer to peer communication via NFC, Bluetooth, Wi-Fi, Audio, or optical communication to communicate via that coupled communication of the computer system as a secondary or primary channel of communication with the virtual bucket.

Thus through the use of the virtual bucket system, there are advantages that can be achieved for transfer of information: ease of use, speedy implementation and use, anonymity between users, and security between users.

Another exemplary embodiment of the invention provides variations on sharing. In this embodiment of the invention, an individual can share a file with another person using a Vbukit system and in an aspect and at the option of the individual, the individual can provide the second user with an option to download the file onto his system. This is depicted, in an exemplary approach, in FIGS. 11-15. The example also showcases the system being used in a zero installation required capability of the system. The system only requires the second user to open a web portal to the virtual bucket system. This web portal requires no special setup, interaction, or login. It automatically sets up all the required security, integration to the specific device, and all other digital environment requirements for second user. This allows the second user to be able to reasonably securely and anonymously send or receive digital files, instantly, via the virtual bucket system, on any electronic device that can run a web service or web application or web browser.

FIG. 11 depicts a file sharing system 505, where a first computing system, e.g., device, 510, intends to share a file with a second computing system, e.g., device, 513. In an aspect, a virtual bucket is used to provide the file from the first device 510 to the second device 513.

A first user on a first device 510 starts a Vbukit or similar application on the first device 510 and then selects the file(s) he wishes to be forwarded to a second device 513. The first user selects a “forward option”—whether the file forwarded is to be shared by or given to the second device. See for example, the “show” “give” toggle icon on the device 510 of FIGS. 12A and 12B. A shared forwarded file is only viewable on the second device 513. A given forwarded file is viewable on the second device 513 and also provides a user of the second device 513 the ability to download the file to the second device 513 and be stored locally. In an aspect, the Vbukit system defaults to a file being shared, not given, unless expressly changed by a first user on the first device 510.

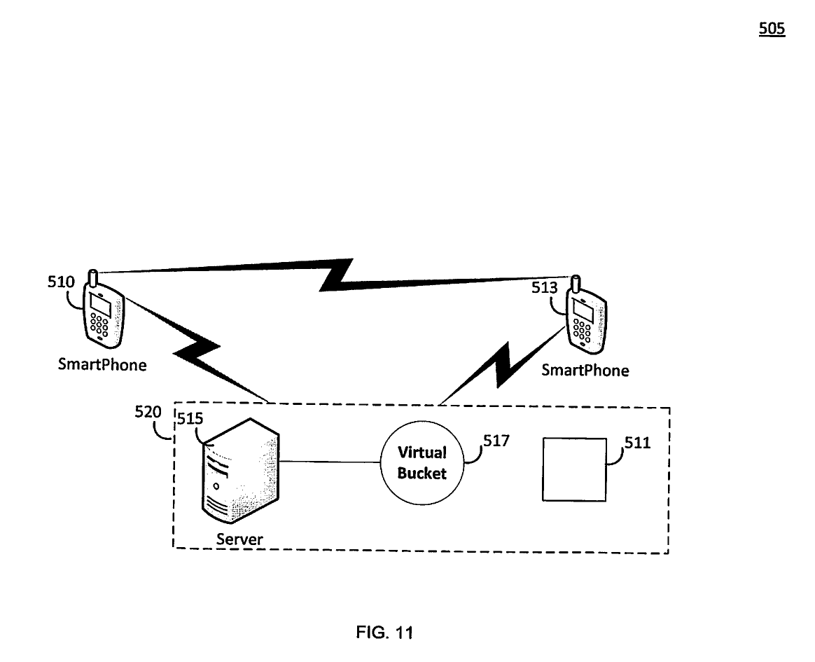

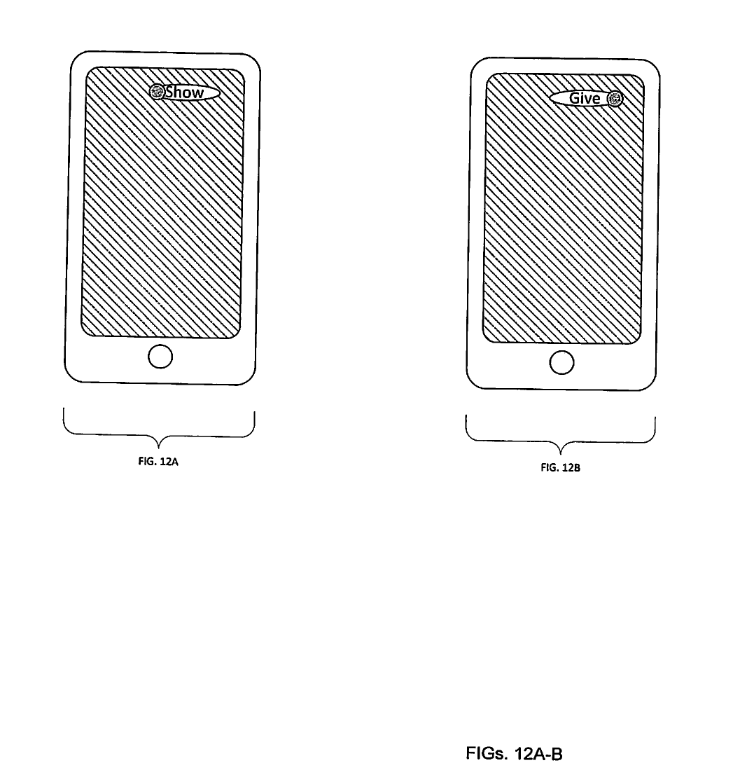

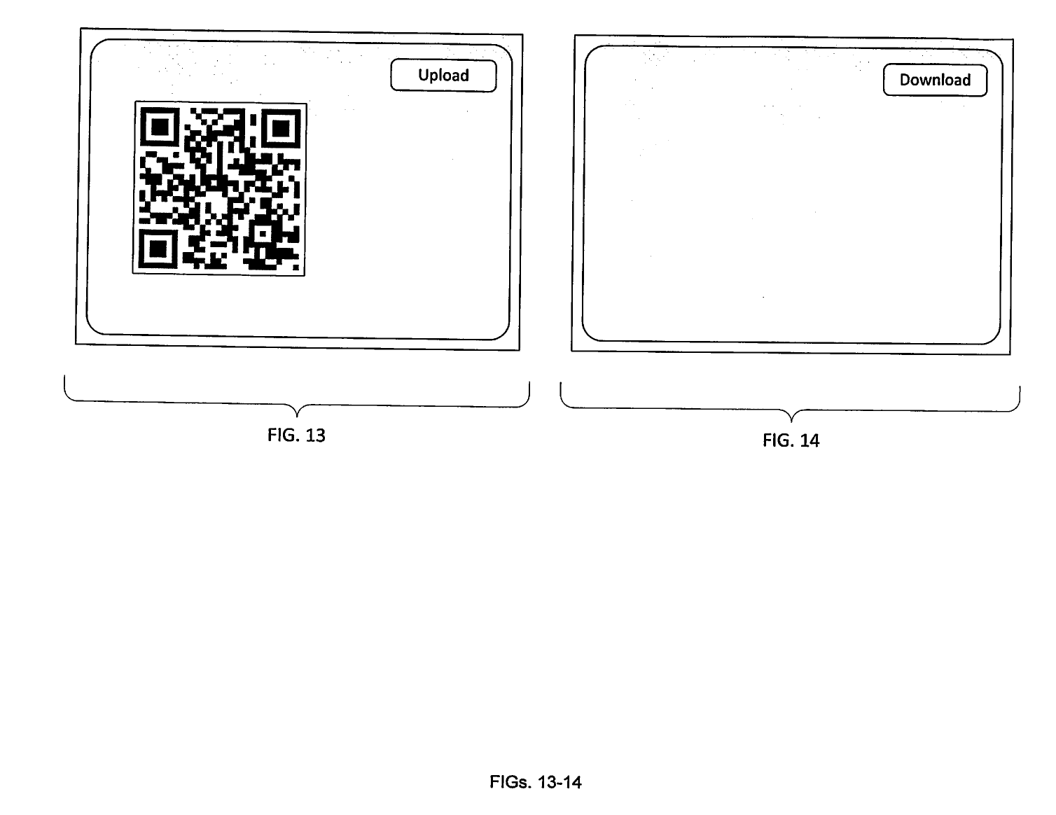

The first device 510 acquires the address of the second device 513. In an aspect, the address (associated with) of the second device is acquired by the first user taking the first device 510 close to the second device 513, whereby the second device 513 is running a Vbukit or similar application and has an address displayed that identifies the second device 513 on the screen on the second device 513, for example, in the form of a three dimensional bar code depicted in FIG. 13. The first user uses the first device 510 to read the address displayed on the second device 513, thereby acquiring the address associated with Vbukit running on the second device 513. In an aspect, the address is not the actual address of the second device 513, but it is a representation or access key to determine a virtual bucket associated with the second device 513. In another aspect, the address is not the actual address of the second device 513, but it is a representation or access key to determine the actual address of the second device. Then the first user sends the first file from the first device 510 to the second device 513 via a Vbukit server system, i.e., the file is uploaded to the server 515 and stored in the virtual bucket 517 associated with the second device 513.

The Vbukit server 515 receives the file from the first device 510, the indication forward option, and the address of the second device 513 from the first device 510. The Vbukit server 515 determines the address of the second device 513 running the Vbukit system using, for example, an internal database which contains cross references. Then the Vbukit server forwards the file and forward option to the Vbukit application running on the second device 513.

The Vbukit application running on the second device 513 receives the file and the indication of the forward option. In an aspect, the application on the second device 513 defaults to automatically displaying in its viewer on the second device 513 the file (or other appropriate action, depending on the type of file. For example, if it is an audio file, then the Vbukit application will cause the file to be played.) If the forward option is set to “give,” then the viewer on the second device 513 will also display a “download” button (See, for example, FIG. 14. If a user on the second device 513 hits the download button, then that will enable the file to be downloaded and stored to the second device 513. Thereby, the file has been saved on the second device 513. If the forward option has been set to “share” then after the file is displayed (or other appropriate action) and the user is done with the file, the file is removed from the Vbukit application running on the second device 513 and is not stored on the second device 513

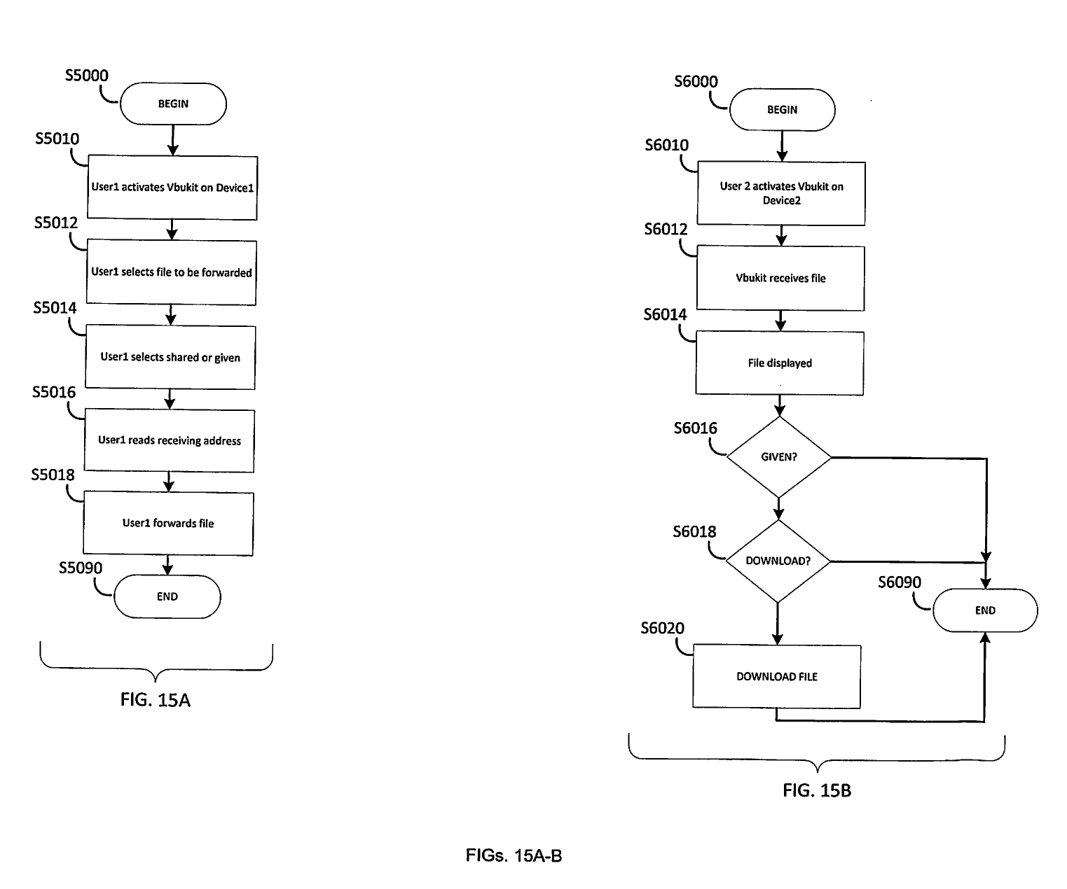

An exemplary operation is depicted for example in FIGS. 15A and 15B, drawing on some of operational details described above with respect to other embodiments and variations of the invention.

FIG. 15A depicts an exemplary operation of the file sharing process from the respect of the giving device.

In Segment S5000, the process begins. Process continues to segment S5010.

In Segment S5010, the first user on a first device 510 starts a virtual bucket program executing on the device. Process continues to segment S5012.

In Segment S5012, the first user selects, using the virtual bucket program, the file to be forwarded to second user's device. Process continues to segment S5014.

In Segment S5014, the first user indicates whether the file being forward to the second user should be shared or given. Process continues to segment S5016.

In Segment S5016, the first user using the first device reads a receiving address for the second device. In an aspect, the second device provides a 3d bar representational of the second device's receiving address, which is read by the first user's device. In other aspects, the second device uses another communication method, e.g., NFC technology, to convey the receiving address to the first device. Process continues to segment S5018.

In Segment S5018, the first user's device forwards the file, the forwarding option (share/give), and the second device's receiving address to the virtual bucket server. Process continues to segment S5090.

In Segment S5090, the process for the first device 510 ends.

As such, the first device has sent the file, the forwarding option (share/give), and the second device's receiving address to the virtual bucket server.

FIG. 15B depicts an exemplary operation of the file sharing process from the respect of the giving device.

In Segment S6000, the process begins. Process continues to segment S6010.

In Segment S6010, a second user on a second device 513 executes a virtual bucket application on the second device 513. The second user indicates to virtual bucket application that the second device will be receiving a file. The second device communicates with the virtual bucket server and indicates that the second device is expecting to receive a file from another device. The virtual bucket server creates a virtual bucket storage location associated with the second device as well as a receiving address for the second device. The virtual bucket server provides the receiving address to the second device. The second device receives the receiving address and provides that address to the first device. Depending on the form in which the receiving address is received, the second device may convert the receiving address to another form. For example, if the server provides the receiving address as a number, the second device converts the number to a 3D barcode. In an aspect, when the providing the receiving address to the first device, the second device, either as part of the receiving address or separately, conveys contact information on how the first device can communicate with the virtual bucket server. The receiving address is conveyed to the first device. Process continues to segment S6012.

In Segment S6012, the virtual bucket server provides the files (e.g., the file and the file option indication) stored at the virtual bucket corresponding to the receiving address to the second device Process continues to segment S6014.

In segment S6104, the second device determines the type of file and displays the file, where display is relative to the type of file. For example, for an audio file, the second device displays the file by playing the file. Process continues to segment S6016.

In Segment S6016, the virtual bucket program on the second device examines the file option for the file. If the file option indicates that the file is to be shared, then the process continues to segment S6090. If the file option indicates that the file is to be given, then the process continues to segment S6018.

In Segment S6018, the second device prompts the second user whether the file should be downloaded from the virtual buck program on the second device and stored on the second device. If the user indicates that the file is to be downloaded, then the process continues to segment S6020. If the user indicates that the file is not to be downloaded, then the process continues to segment S6090.

In Segment S6020, the second device downloads the file from the virtual bucket program onto local storage on the second device and is stored. Process continues to segment S6090.

In another aspect, a first user runs a virtual bucket system on a first device 510 using a web portal on the first device 510. The distinction is that a web portal is not a downloaded application. It is a website accessed using the Internet communication abilities of the first device. Using virtual bucket's zero login capabilities, the second user, opening this web portal, is now able to relatively instantly send or receive files from the first user's device 510 without the need of an login credentials, yet still be able to maintain a relatively high level of security and anonymity when receiving or sending the file. Traditional methods, either based on installed applications or based on web app/services, require a point to point connection or require some form of identification or credentials by the user to maintain security. This first, removes the ability for anonymity because the credential is traditionally that of the user and is repeatedly used. Second, a user will commonly use the same credential for many vulnerable systems such as using the same password for social media that they use for their bank login. Using zero login and the web portal for virtual bucket, the user now requires no special login, yet maintains even higher security and complete anonymity while sending or receiving a file. The user also requires no special installation of an application, allowing the user to instantly be available to access the capabilities of secure and anonymous instant transfer of files using the virtual bucket system.

The system can also allow the first user, the option of using the web portal to share or give the file to the second user. See, for example, the “Upload” button in FIG. 13. The system allows complete control on both sides of the transaction, to either show or give the file, and to interact with the file on the receiving party's device, without creating vulnerabilities on the receiving party's device. Similarly, a user can select to download a file. See, for example, the “Download” button in FIG. 14. In another embodiment of the invention, as noted above, both parties can use the web portal based system, to share or give files, without requiring installation of any specific application or requiring any login credentials, while still maintaining a higher level of security and anonymity compared to traditional methods.

Other example uses of the virtual bucket system where User A is the receiver and User B is the sender.

User A has a tablet. User B wishes to show a power point presentation on User A's tablet and control which slide is shown on the tablet.

User A has a PC with a Browser. User B wishes to show a website or online content on User A's PC Browser and control scrolling on the PC Browser.

User A has a home automation system. User B wishes to control the lights or temperature in User A's home via User A's home automation system. User B can have temporary access to control some or all devices and dynamically control or change the state of those devices such as turning lights on or off or changing the temperature.

User A is a TV in a hotel room. User B is a guest who wishes to control the TV via their phone, but access the requests in complete anonymity. User B can link via the bucket to actively control that TV without needing to use a direct point to point method such as a direct wireless connection or via a network connection of the hotel that links to the TV. Using virtual bucket, all the controls are there on the phone of User B, and full or partial interaction between user B's phone and User A's TV is available, but neither party knows the other and use the virtual bucket to securely and anonymously communicate with each other. In this case, the unique bucket ID was broadcast via Wi-Fi, where the Wi-Fi router dynamically changes their SSID or other generally accepted broadcast information. This dynamically changed SSID represents the unique bucket ID. When User B activates their devices virtual bucket system, the system can listen or open for receiving specific method of broadcast or unique structure/identifiers that tell it that a specific piece of information being broadcast is a unique bucket ID. User B's device can then receiver that bucket ID based on what it has read, received, or interpreted from the Wi-Fi SSID and uses that information to access the corresponding bucket to that unique bucket ID.

User A has a stereo. User B wishes to play songs on User A's stereo and control which songs in what order are played. In the case of the stereo, the method for broadcasting the unique bucket ID to User B's device can include but is not limited to a sonic beacon. This beacon is activated by User A via their phone as a bridge device to User A's stereo. When user A activates the virtual bucket application on their smart phone to link to their stereo, this application will request and receive the unique bucket ID for this specific deposit/withdrawal. The smart phone or server can recognize that this is to be used with a device that can generate sound. Therefore the unique ID can be broadcast to User B using a grouping of sounds that when heard by User B's device, can be interpreted into a unique bucket ID. Once the unique bucket ID is received, the process continues to connect to that specific bucket and allow User B to deposit a file.

There are countless methods of using virtual bucket for sending and receiving files, data, information, interaction, control, and more. All anonymously and securely based on the method of depositing and withdrawing from the virtual bucket and removing all liability of a point to point connection with a trusted self-destructing middle man.

While the invention has been described and illustrated with reference to specific exemplary embodiments, it should be understood that many modifications, combinations, and substitutions can be made without departing from the spirit and scope of the invention. For example, an operation described as occurring in software is not necessarily limited to be implemented in software and can be partially, substantially, or completely implemented in hardware. Similarly, an operation described as occurring in hardware is not necessarily limited to be implemented in hardware and can be partially, substantially, or completely implemented in software. Furthermore, although aspects of the invention are described with respect to using NFC communications and NFC tags, the invention is not so limited and many of these aspects can be implemented using other systems. For example, RFID systems, barcodes, scan codes, 3D readers, QR codes, etc, can be employed. Accordingly, the invention is not to be considered as limited by the foregoing description but is only limited by the scope of the claims.

What is claimed as new and desired to be protected by Letters Patent of the United States is:

1. A method for transferring an electronic data between a first computer system and a second computer system using a third computer system, comprising the steps of:
creating, by said third computer system, a temporary storage location in said third computer system;
creating, by said third computer system, a unique identifier associated with said temporary storage location;
providing said unique identifier to said second computer system; and
reading, by said first computer system, said unique identifier from said second computer system.

2. The method of claim 1, further comprising the steps of:
providing said electronic data and said unique identifier to said third computer system, by said first computer system.

3. The method of claim 2, further comprising the steps of:
receiving, by said third computer system, said data;
determining, by said third computer system, said temporary storage location associated with said unique identifier; and
storing, by said third computer system, said data in said temporary storage location.

4. The method of claim 3, further comprising the steps of:
requesting, by said second computer system based on a unique identifier, a stored data; and
determining, by said third computer system, said temporary storage location based on at least part of said unique identifier provided by second computer system;
providing, by said third computer system, said data stored in said temporary storage location to said second computer system.

5. The method of claim 1, further comprising the steps of:
converting, by said second computer system, said unique identifier to a 3d Barcode; and
displaying, by said second computer system, said 3d Barcode.

6. The method of claim 5, wherein reading, by said first computer system, said unique identifier from said second computer system further comprises reading said 3d bar code from second computer system.

7. A method for transferring an electronic data between a first computer system and a second computer system using a third computer system, comprising the steps of:
accessing a third computer system using a Web Portal on said second computer system;
creating, by said third computer system, a temporary storage location in said third computer system;
creating, by said third computer system, a unique identifier associated with said temporary storage location;
providing said unique identifier to said second computer system; and
reading, by said first computer system, said unique identifier from said second computer system.

8. The method of claim 7, further comprising the steps of:
providing said electronic data and said unique identifier to said third computer system, by said first computer system.

9. The method of claim 8, further comprising the steps of:
receiving, by said third computer system, said data;
determining, by said third computer system, said temporary storage location associated with said unique identifier; and
storing, by said third computer system, said data in said temporary storage location.

10. The method of claim 9, further comprising the steps of:
requesting, by said second computer system based on a unique identifier, a stored data; and
determining, by said third computer system, said temporary storage location based on at least part of said unique identifier provided by second computer system;
providing, by said third computer system, said data stored in said temporary storage location to said second computer system.

11. The method of claim 7, further comprising the steps of:
converting, by said second computer system, said unique identifier to a 3d Barcode; and
displaying, by said second computer system, said 3d Barcode.

12. The method of claim 11, wherein reading, by said first computer system, said unique identifier from said second computer system further comprises reading said 3d bar code from second computer system.

13. A method for transferring an electronic data between a first computer system and a second computer system using a third computer system, comprising the steps of:
executing a data transfer app on said second computer system;
accessing said third computer system using said data transfer app on said second computer system;
creating, by said third computer system, a temporary storage location in said third computer system;
creating, by said third computer system, a unique identifier associated with said temporary storage location;
providing said unique identifier to said second computer system; and
reading, by said first computer system, said unique identifier from said second computer system.

14. The method of claim 13, further comprising the steps of:
providing said electronic data and said unique identifier to said third computer system, by said first computer system.

15. The method of claim 14, further comprising the steps of:
receiving, by said third computer system, said data;
determining, by said third computer system, said temporary storage location associated with said unique identifier; and
storing, by said third computer system, said data in said temporary storage location.

16. The method of claim 15, further comprising the steps of:
requesting, by said second computer system based on a unique identifier, a stored data; and
determining, by said third computer system, said temporary storage location based on at least part of said unique identifier provided by second computer system;
providing, by said third computer system, said data stored in said temporary storage location to said second computer system.

17. The method of claim 13, further comprising the steps of:
converting, by said second computer system, said unique identifier to a 3d Barcode; and
displaying, by said second computer system, said 3d Barcode.

18. The method of claim 17, wherein reading, by said first computer system, said unique identifier from said second computer system further comprises reading said 3d bar code from second computer system.
